(19) United States
(12) Patent Application Publication
(10) Pub. No.: US 2022/0080553 A1
(43) Pub. Date: Mar. 17, 2022

(54) RAPID CURING BONDED ABRASIVE ARTICLE PRECURSOR

(71) Applicant: 3M INNOVATIVE PROPERTIES COMPANY, St Paul, MN (US)

(72) Inventors: Brett A. Beiermann, St. Paul, MN (US); Maiken Givot, St. Paul, MN (US); Mayank Puri, Minneapolis, MN (US); Rachel J. Clark, Oakdale, MN (US); Henrik Knutsson, Västervik (SE)

(21) Appl. No.: 17/309,756

(22) PCT Filed: Dec. 16, 2019
(86) PCT No.: PCT/IB2019/060842

§ 371 Date: Jun. 17, 2021

Related U.S. Application Data
(60) Provisional application No. 62/780,956, filed on Dec. 18, 2018.

(51) Int. Cl. B24D 3/28; B24D 18/00; C09K 3/14

(52) U.S. Cl. CPC B24D 3/28; C09K 3/1409; B24D 18/0009

(57) ABSTRACT

According to various embodiment of the present disclosure, a bonded abrasive article precursor includes a curable composition. The curable composition includes a curative component. The curable composition further includes one or more resins. The curable composition further includes a plurality of shaped abrasive particles. The curable composition is curable in an amount of time in a range of from about 0.1 minutes to about 20 minutes at a temperature of about 25° C. to about 160° C.

### BACKGROUND

Abrasive particles and abrasive articles including the abrasive particles are useful for abrading, finishing, or grinding a wide variety of materials and surfaces in the manufacturing of goods. As such, there continues to be a need for improving the cost, performance, and ease of manufacturing abrasive articles.

### SUMMARY OF THE DISCLOSURE

According to various embodiment of the present disclosure, a bonded abrasive article precursor includes a curable composition. The curable composition includes a curative component. The curable composition further includes one or more resins. The curable composition further includes a plurality of shaped abrasive particles. The curable composition is curable in an amount of time in a range of from about 0.1 minutes to about 20 minutes at a temperature of about 25° C. to about 160° C.

According to various embodiments of the present disclosure, a bonded abrasive article can include a cured product of a curable composition. The curable composition includes a curative component. The curable composition further includes one or more resins. The curable composition further includes a plurality of shaped abrasive particles. The curable composition is curable in an amount of time in a range of from about 0.1 minutes to about 20 minutes at a temperature of about 25° C. to about 160° C.

According to various embodiments of the present disclosure, a method of making a bonded abrasive article includes curing a curable composition. The curable composition includes a curative component. The curable composition further includes one or more resins. The curable composition further includes a plurality of shaped abrasive particles. The curable composition is curable in an amount of time in a range of from about 0.1 minutes to about 20 minutes at a temperature of about 25° C. to about 160° C.

According to various embodiments of the present disclosure, a method of using an abrasive article includes moving the abrasive article with respect to a surface contacted therewith, to abrade the surface. The bonded abrasive article can include a cured product of a curable composition. The curable composition includes a curative component. The curable composition further includes one or more resins. The curable composition further includes a plurality of shaped abrasive particles. The curable composition is curable in an amount of time in a range of from about 0.1 minutes to about 20 minutes at a temperature of about 25° C. to about 160° C.

There are many reasons to use the bonded abrasive article precursors of the present disclosure. For example, according to various embodiments, the bonded abrasive article precursors of the present disclosure can be rapidly cured at low temperatures. This can make it much quicker to produce bonded abrasive articles in comparison to conventional phenolic resin bonded abrasives, which require comparatively long cure times that can be around 10 hours and high temperatures. According to various embodiments reactants in the curable composition can be rapidly cured, e.g., more than 95% of the reaction exotherm has been consumed in less than 20 minutes. According to further embodiments, curing can occur concurrently with forming, such that the curable composition does not need to be first placed in a mold and then transported to an oven for cuing.

### BRIEF DESCRIPTION OF THE FIGURES

The drawings illustrate generally, by way of example, but not by way of limitation, various embodiments discussed in the present document.

FIGS. 1A and 1B show shaped abrasive particles having a truncated pyramidal shape, in accordance with various embodiments.

FIGS. 2A-2E show various embodiments of tetrahedral shaped abrasive particles, in accordance with various embodiments.

FIG. 3 shows a cylindrical shaped abrasive particle, in accordance with various embodiments.

FIG. 4 shows a bowtie shaped abrasive particle, in accordance with various embodiments.

FIG. 5 shows an elongated shaped abrasive particle, in accordance with various embodiments.

FIG. 6 shows another embodiment of an elongated shaped abrasive particle, in accordance with various embodiments.

FIG. 7 is a perspective view of a bonded abrasive article, in accordance with various embodiments.

FIG. 8 is a sectional view of the bonded abrasive article of FIG. 7 taken along line 2-2, in accordance with various embodiments.

FIG. 9 is a sectional perspective view of an apparatus for making the bonded abrasive article precursor according to various embodiments.

FIG. 10 is another sectional perspective view of the apparatus for making the bonded abrasive article precursor according to various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The polymers described herein can terminate in any suitable way. In various embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

According to various embodiments of the present disclosure, a bonded abrasive article can be formed, at least in part, from a bonded abrasive article precursor. The bonded abrasive article precursor can include a curable composition that is capable of being cured in a time frame ranging from about 0.1 minutes to about 20 minutes, 0.5 minutes to about 15 minutes, 1 minute to about 10 minutes, less than, equal to, or greater than about 0.5 minutes, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 minutes. In addition to the rapid rate of curing, the curable composition is capable of curing at a low temperature such as room temperature, or at a temperature in a range of from about 25° C. to about 160° C., about 100° C. to about 150° C., less than, equal to, or greater than about 25° C., 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, or about 160° C. According to various embodiments, the curable composition can be an epoxy composition, a polyacrylate composition, or a polyurethane composition. Although epoxy compositions, polyacrylate compositions, and polyurethanes compositions are mentioned, it is possible to have any other suitable curable composition in the bonded abrasive articles described herein.

The curable composition can include any number of components. For example, the curable composition can include one or more curative components as well as one or more resins that are capable of being cured by the curable component. The curable composition can further include one or more abrasive particles disposed therein.

The curative component can be in a range of from about 0.1 wt % to about 40 wt % of the curable composition about 0.1 wt % to about 10 wt %, less than, equal to, or about 0.1 wt %, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, or about 40 wt %. The curative component can be generally classified as a catalyst, linker, or extender. Specific, non-limiting examples, of curative components include an acid catalyst (e.g., a Lewis acid), a base catalyst (e.g., a Lewis base), an amphoteric catalyst (e.g., a catalyst capable of being a Lewis acid or a Lewis base). Further specific examples of curative components include, an aliphatic polyamine, an aromatic polyamine, an aromatic polyamide, an alicyclic polyamine, a polyamine, a polyamide, an amino resin, a 9,9-bis(aminophenyl)fluorene, a polyisocyanate, a polyol chain extender. Examples of acid catalysts include antimony hexafluoride, a diazonium salt, an idonium salt, a sulfonium salt, a ferrocenium salt, or a mixture thereof. Examples of base catalysts include an imidazole, a dicyandiamide an amine-functional catalyst, a compound including reactive —NH groups or reactive —NR¹R² groups wherein R¹ and R² are independently H or (C₁ to C₄)alkyl, or —H, methyl or a mixture thereof. In some circumstances the imidazole, dicyandiamide, or both can be amphoteric.

Examples of a polyisocyanate can include dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, toluene diisocyanate, diphenylmethane 4,4′-diisocyanate, 1,4-diisocyanatobutane, 1,8-diisocyanatooctane, or a mixture thereof.

Examples of suitable 9,9-bis(aminophenyl)fluorene compounds include 9,9-bis(4-aminophenyl)fluorene, 4-methyl-9,9-bis(4-aminophenyl)fluorene, 4-chloro-9,9-bis(4-aminophenyl)fluorene, 2-ethyl-9,9-bis(4-aminophenyl)fluorene, 2-iodo-9,9-bis(4-aminophenyl)fluorene, 3-bromo-9,9-bis(4-aminophenyl)fluorene, 9-(4-methylaminophenyl)-9-(4-ethylaminophenyl)fluorene, 1-chloro-9,9-bis(4-aminophenyl)fluorene, 2-methyl-9,9-bis(4-aminophenyl)fluorene, 2,6-dimethyl-9,9-bis(4-aminophenyl)fluorene, 1,5-dimethyl-9,9-bis(4-aminophenyl)fluorene, 2-fluoro-9,9-bis(4-aminophenyl)fluorene, 1,2,3,4,5,6,7,8-octafluoro-9,9-bis(4-aminophenyl)fluorene, 2,7-dinitro-9,9-bis(4-aminophenyl)fluorene, 2-chloro-4-methyl-9,9-bis(4-aminophenyl)fluorene, 2,7-dichloro-9,9-bis(4-aminophenyl)fluorene, 2-acetyl-9,9-bis(4-aminophenyl)fluorene, 2-methyl-9,9-bis(4-methylaminophenyl)fluorene, 2-chloro-9,9-bis(4-ethylaminophenyl)fluorene, 2-t-butyl-9,9-bis(4-methylaminophenyl)fluorene, 9,9-bis(3-methyl-4-aminophenyl)fluorene, 9-(3-methyl-4-aminophenyl)-9-(3-chloro-4-aminophenyl)fluorene, 9-bis(3-methyl-4-aminophenyl)fluorene, 9,9-bis(3-ethyl-4-aminophenyl)fluorene, 9,9-bis(3-phenyl-4-aminophenyl)fluorene, 9,9-bis(3,5-dimethyl-4-methylaminophenyl)fluorene, 9,9-bis(3,5-dimethyl-4-aminophenyl)fluorene, dimethyl-4-methylaminophenyl)-9-(3,5-dimethyl-4-aminophenyl)fluorene, 9-(3,5-diethyl-4-aminophenyl)-9-(3-methyl-4-aminophenyl)fluorene, 1,5-dimethyl-9,9-bis(3,5-dimethyl-4-methylaminophenyl)fluorene, 9,9-bis(3,5-diisopropyl-4-aminophenyl)fluorene, 9,9-bis(3-chloro-4-aminophenyl)fluorene, 9,9-bis(3,5-dichloro-4-aminophenyl)fluorene, 9,9-bis(3,5-diethyl-4-methylaminophenyl)fluorene, 9,9-bis(3,5-diethyl-4-aminophenyl)fluorene, and a mixture thereof.

Examples of suitable polyol chain extenders include ethylene glycol, a poly(ethylene glycol), diethylene glycol, triethylene glycol, tetraethylene glycol, propylene glycol, a poly(propylene glycol), dipropylene glycol, tripropylene glycol, 1,3-propanediol, 1,3-butanediol, 1,4-butanediol, neopentyl glycol, 1,6-hexanediol, 1,4-cyclohexanedimethanol, or a mixture thereof.

In the curable composition, the one or more resins can be in a range of from about 20 wt % to about 99.9 wt % of the curable composition, about 25 wt % to about 70 wt % of the curable composition, less than, equal to, or greater than about 25 wt %, 25.5, 26. 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, or about 70 wt %. The curable resins can include an epoxy resin, an acrylated epoxy resin, a polyester polyol, or a mixture thereof. In various embodiments the polyisocyanate, the polyol, or a mixture thereof may also be considered as a curable resin.

In embodiments where the curable resin includes one or more epoxy resins examples of epoxy resins can include a diglycidyl ether of bisphenol F, a low epoxy equivalent weight diglycidyl ether of bisphenol A, a liquid epoxy novolac, a liquid aliphatic epoxy, a liquid cycloaliphatic epoxy, a 1,4-cyclohexandimethanoldiglycidylether, 3,4-epoxycyclohexylmethyl-3,4-epoxycyclohexane carboxylate, tetraglycidylmethylenedianiline, N,N,N′,N′-tetraglycidyl-4,4′-methylenebisbenzenamine, a triglycidyl of para-aminophenol, N,N,N′,N′-tetraglycidyl-m-xylenediamine, an acrylated epoxy resin, and a mixture thereof.

In embodiments in which the epoxy resin includes an acrylated epoxy resin, the epoxy resin can include a tetrahydrofurfuryl (THF) (meth)acrylate copolymer component, one or more epoxy resins (such as those disclosed herein), and one or more hydroxy-functional polyethers. According to various embodiments, the THF (meth)acrylate copolymer component can be in a range of from about 15 to about 50 parts by weight, about 20 to about 40 parts by weight, less than, equal to, or greater than about 15, 20, 25, 30, 35, 40, 45, or 50 parts by weight. The one or more epoxy resins can be in a range of from about 25 to about 50 parts by weight, about 20 to about 40 parts by weight, less than, equal to, or greater than about 15, 20, 25, 30, 35, 40, 45, or 50 parts by weight. According to various embodiments, the hydroxy-functional polyethers can be in a range of from about 5 to about 15 parts by weight, about 7 to about 10 parts by weight, less than, equal to, or greater than about 5 parts by weight, 6, 7, 8, 9, 10, 11, 12, 13, 14, or about 15 parts by weight. According to various embodiments, in which the epoxy resin includes an acrylated epoxy resin, the acrylated epoxy resin can include one or more hydroxyl-containing film-forming polymers, which can range from about 10 to about 25 parts by weight, about 15 to about 20 parts by weight, less than, equal to, or greater than about 10 parts by weight, 15, 20, or about 25 parts by weight. According to various embodiments in which the epoxy resin includes an acrylated epoxy resin, the acrylated epoxy resin can include one or more photoinitiators, which can range from about 0.1 to about 5 parts by weight, about 1 to about 3 parts by weight, less than, equal to, or greater than about 0.1 parts by weight, 0.5, 1, 1.5, 2, 2.5, 3, 3.5, 4, 4.5, or about 5 parts by weight.

The THF (meth)acrylate copolymer component can include one or more THF (meth)acrylate monomers, one or more Ci-Cs (meth)acrylate ester monomers, and one or more optional cationically reactive functional (meth)acrylate monomers. The tetrahydrofurfuryl (meth)acrylate monomers can be in a range of from about 40 wt % to about 60 wt % of the THF (meth)acrylate copolymer component, about 50 wt % to about 55 wt %, less than, equal to, or greater than about 40 wt %, 41, 42, 43, 44, 45, 46, 47, 48, 49, 50, 51, 52, 53, 54, 55, 56, 57, 58, 59, or about 60 wt %. The one or more Ci-Cs (meth)acrylate ester monomers can be in a range of from about 40 wt % to about 60 wt % of the THF (meth)acrylate copolymer component, about 50 wt % to about 55 wt %, less than, equal to, or greater than about 40 wt %, 41, 42, 43, 44, 45, 46, 47, 48, 49, 50, 51, 52, 53, 54, 55, 56, 57, 58, 59, or about 60 wt %. The cationically reactive functional (meth)acrylate monomers can be in a range of from 0 wt % to about 10 wt % of the THF (meth)acrylate copolymer component, about 2 wt % to about 5 wt %, less than, equal to, or greater than about 0 wt %, 1, 2, 3, 4, 5, 6, 7, 8, 9, or about 10 wt %.

In embodiments, where the one or more resins include a polyester polyol, the polyester polyol can include polyglycolic acid, polybutylene succinate, poly(3-hydroxybutyrate-co-3-hydroxyvalerate), polyethylene terephthalate, polybutylene terephthalate, polytrimethylene terephthalate, polyethylene naphthalate, poly(1,4-butylene adipate), poly(1,6-hexamethylene adipate), poly(ethylene-adipate), mixtures thereof, or copolymers thereof.

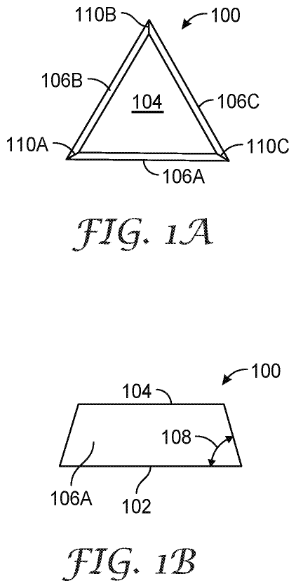

The abrasive particles of the bonded abrasive article precursor can include shaped abrasive particles, crushed or conventional abrasive particles, or mixtures thereof For example, FIGS. 1A and 1B show shaped abrasive particles 100, which are generally triangular shaped abrasive particles. As shown in FIGS. 1A and 1B, shaped abrasive particle 100 includes a truncated regular triangular pyramid bounded by a triangular base 102, a triangular top 104, and plurality of sloping sides 106A, 106B, 106C connecting triangular base 102 (shown as equilateral although scalene, obtuse, isosceles, and right triangles are possible) and triangular top 104. Slope angle 108 is the dihedral angle formed by the intersection of side 106A with triangular base 102. Similarly, slope angles 108B and 108C (both not shown) correspond to the dihedral angles formed by the respective intersections of sides 106B and 106C with triangular base 102. In the case of shaped abrasive particle 100, all of the slope angles have equal value. In various embodiments, side edges 110A, 110B, and 110C have an average radius of curvature in a range of from about 0.5 μm to about 80 μm, about 10 μm to about 60 μm, or less than, equal to, or greater than about 0.5 μm, 5, 10, 15, 20, 25, 30, 35, 40, 45, 50, 55, 60, 65, 70, 75, or about 80 μm.

In the embodiment shown in FIGS. 1A and 1B, sides 106A, 106B, and 106C have equal dimensions and form dihedral angles with the triangular base 102 of about 82 degrees (corresponding to a slope angle of 82 degrees). However, it will be recognized that other dihedral angles (including 90 degrees) may also be used. For example, the dihedral angle between the base and each of the sides may independently range from 45 to 90 degrees (for example, from 70 to 90 degrees, or from 75 to 85 degrees). Edges connecting sides 106, base 102, and top 104 can have any suitable length. For example, a length of the edges may be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm.

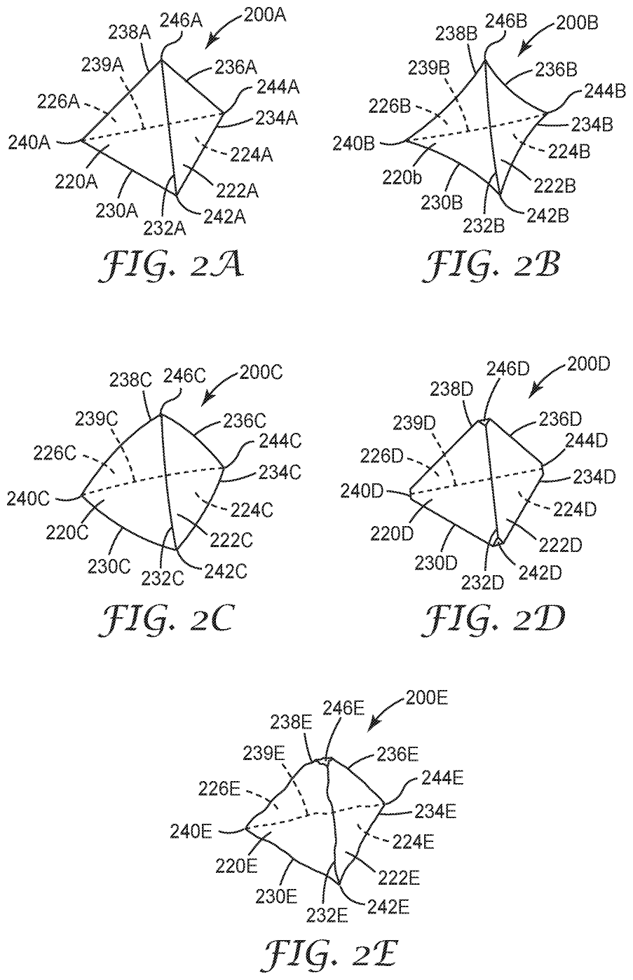

Although FIGS. 1A and 1B show triangular shaped abrasive particles 100, there are many other suitable examples of shaped abrasive particles that may be included in bonded abrasive article precursor. For example, bonded abrasive article precursor can include tetrahedral shaped abrasive particles. FIGS. 2A-2E show various embodiments of tetrahedral shaped abrasive particles 200. As shown in FIGS. 2A-2E, shaped abrasive particles 200 are shaped as regular tetrahedrons. As shown in FIG. 2A, shaped abrasive particle 200A has four faces (220A, 222A, 224A, and 226A) joined by six edges (230A, 232A, 234A, 236A, 238A, and 239A) terminating at four vertices (240A, 242A, 244A, and 246A). Each of the faces contacts the other three of the faces at the edges. While a regular tetrahedron (e.g., having six equal edges and four faces) is depicted in FIG. 2A, it will be recognized that other shapes are also permissible. For example, tetrahedral abrasive particles 200 can be shaped as irregular tetrahedrons (e.g., having edges of differing lengths).

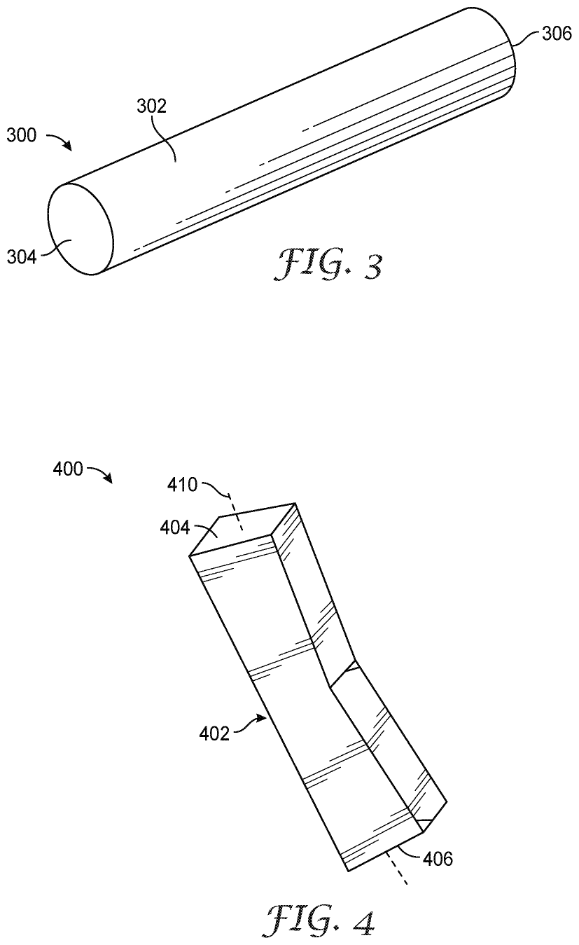

Referring now to FIG. 2B, shaped abrasive particle 200B has four faces (220B, 222B, 224B, and 226B) joined by six edges (230B, 232B, 234B, 238B, and 239B) terminating at four vertices (240B, 242B, 244B, and 246B). Each of the faces is concave and contacts the other three of the faces at respective common edges. While a particle with tetrahedral symmetry (e.g., four rotational axes of threefold symmetry and six reflective planes of symmetry) is depicted in FIG. 3B, it will be recognized that other shapes are also permissible. For example, shaped abrasive particles 200B can have one, two, or three concave faces with the remainder being planar.

Referring now to FIG. 2C, shaped abrasive particle 200C has four faces (220C, 222C, 224C, and 226C) joined by six edges (230C, 232C, 234C, 236C, 238C, and 239C) terminating at four vertices (240C, 242C, 244C, and 246C). Each of the faces is convex and contacts the other three of the faces at respective common edges. While a particle with tetrahedral symmetry is depicted in FIG. 2C, it will be recognized that other shapes are also permissible. For example, shaped abrasive particles 200C can have one, two, or three convex faces with the remainder being planar or concave.

Referring now to FIG. 2D, shaped abrasive particle 200D has four faces (220D, 222D, 224D, and 226D) joined by six edges (230D, 232D, 234D, 236D, 238D, and 239D) terminating at four vertices (240D, 242D, 244D, and 246D). While a particle with tetrahedral symmetry is depicted in FIG. 2D, it will be recognized that other shapes are also permissible. For example, shaped abrasive particles 200D can have one, two, or three convex faces with the remainder being planar.

Deviations from the depictions in FIGS. 2A-2D can be present. An example of such a shaped abrasive particle 200 is depicted in FIG. 2E, showing shaped abrasive particle 200E, which has four faces (220E, 222E, 224E, and 226E) joined by six edges (230E, 232E, 234E, 238E, and 239E) terminating at four vertices (240E, 242E, 244E, and 246E). Each of the faces contacts the other three of the faces at respective common edges. Each of the faces, edges, and vertices has an irregular shape.

In any of shaped abrasive particles 200A-200E, the edges can have the same length or different lengths. The length of any of the edges can be any suitable length. As an example, the length of the edges can be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm. Shaped abrasive particles 200A-200E can be the same size or different sizes.

In other embodiments, shaped abrasive particles may be shaped as a cylinder as shown in FIG. 3. FIG. 3 is a perspective view showing shaped abrasive particle 300. Shaped abrasive particle 300 includes a cylindrically shaped body 302 extending between circular first and second ends 304 and 306.

In other embodiments, shaped abrasive particles may be shaped to have a bowtie shape as shown in FIG. 4. FIG. 4 is a perspective view of abrasive particle 400. Abrasive particle 400 includes elongated body 402, which is defined between opposed first end 404 and second end 406, having axis 410 extending through each end. An aspect ratio of a length to a width of abrasive particle 400 can range from about 3:1 to about 6:1, or from about 4:1 to about 5:1.

Axis 410 extends through the middle of elongated body 402, first end 404, and second end 406. As illustrated, axis 410 is a non-orthogonal axis, but in other embodiments, axis 410 can be a straight axis. As illustrated, each of first end 404 and second end 406 define a substantially planar surface. Both first end 404 and second end 406 are oriented at an angle relative to axis 410 that is less than 90 degrees, and each end is non-parallel with respect to each other. In other embodiments, only one of first and second ends 404 and 406 are oriented at an angle relative to axis 410 that is less than 90 degrees. First end 404 and second end 406 have respective first and second cross-sectional areas. As illustrated, the first and second cross-sectional areas are substantially the same. But in other embodiments, the first and second cross-sectional areas can be different. Elongated body 402 tapers inward from first end 404 and second end 406 to a mid-point having a cross-sectional area that is smaller than that of first or second ends 404 and 406.

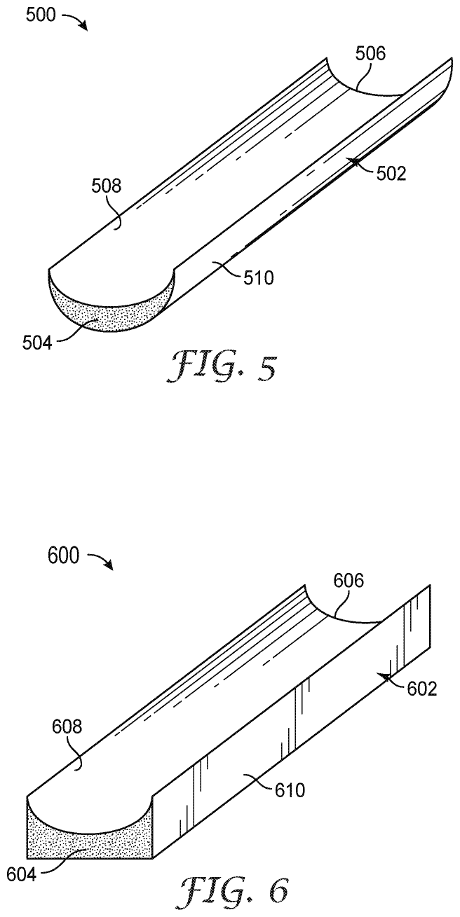

In other embodiments, as shown in FIG. 5, shaped abrasive particle 500 has an elongate shaped ceramic body 502 having opposed first and second ends 504, 506 joined to each other by longitudinal sidewalls 508, 510. Longitudinal sidewall 508 is concave along its length. First and second ends 504 and 506 are fractured surfaces.

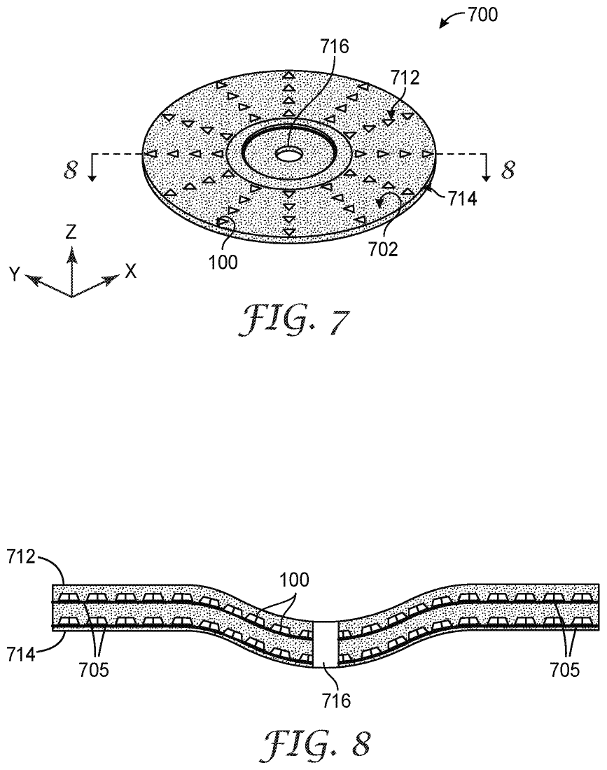

In other embodiments, as shown in FIG. 6, shaped abrasive particle 600 has an elongate shaped ceramic body 602 having opposed first and second ends 604, 606 joined to each other by longitudinal sidewalls 608 and 610. Longitudinal sidewall 608 is concave along its length. First and second ends 604, 606 are fractured surfaces. Shaped abrasive particles 500 and 600 have an aspect ratio of at least 2. In various embodiments, shaped abrasive particles 500 and 600 have an aspect ratio of at least 4, at least 6, or even at least 10.

Any of shaped abrasive particles 100, 200, 300, 400, 500, or 600 can include any number of shape features. The shape features can help to improve the cutting performance of any of shaped abrasive particles 100, 200, 300, 400, 500, or 600. Examples of suitable shape features include an opening, a concave surface, a convex surface, a groove, a ridge, a fractured surface, a low roundness factor, or a perimeter comprising one or more corner points having a sharp tip. Individual shaped abrasive particles can include any one or more of these features.

According to various embodiments, the bonded abrasive article precursor can include one or more fillers or grinding aids. Grinding aids can be effective in abrading stainless steel, exotic metal alloys, titanium, metals slow to oxidize, and so forth. In some instances, a bonded abrasive product including a grinding aid can abrade more stainless steel than a corresponding bonded abrasive product which is devoid of a grinding aid. It is believed that one function of a grinding aid is to prevent metal capping by rapidly contaminating the freshly formed metal surface. Examples of common grinding aids or fillers include sodium aluminum hexafluoride (e.g., cryolite), sodium chloride, potassium tetrafluoroborate (KBF₄), iron pyrite, polyvinyl chloride, calcium carbonate, and polyvinylidene chloride.

The bonded abrasive article precursor can also include conventional (e.g., crushed) abrasive particles as opposed to, on in addition to, any of the shaped abrasive particles described herein. The conventional abrasive particles can, for example, have an average diameter ranging from about 10 μm to about 5000 μm, about 20 μm to about 200 μm, about 50 μm to about 1000 μm, less than, equal to, or greater than about 10 μm, 20, 30, 40, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1650, 1700, 1750, 1800, 1850, 1900, 1950, 2000, 2050, 2100, 2150, 2200, 2250, 2300, 2350, 2400, 2450, 2500, 2550, 2650, 2700, 2750, 2800, 2850, 2900, 2950, 3000, 3050, 3100, 3150, 3200, 3250, 3300, 3350, 3400, 3450, 3500, 3550, 3650, 3700, 3750, 3800, 3850, 3900, 3950, 4000, 4050, 4100, 4150, 4200, 4250, 4300, 4350, 4400, 4450, 4500, 4550, 4650, 4700, 4750, 4800, 4850, 4900, 4950, or about 5000 μm. For example, the conventional abrasive particles can have an abrasives industry-specified nominal grade. Such abrasives industry-accepted grading standards include those known as the American National Standards Institute, Inc. (ANSI) standards, Federation of European Producers of Abrasive Products (FEPA) standards, and Japanese Industrial Standard (HS) standards. Exemplary ANSI grade designations (e.g., specified nominal grades) include: ANSI 12 (1842 μm), ANSI 16 (1320 μm), ANSI 20 (905 μm), ANSI 24 (728 μm), ANSI 36 (530 μm), ANSI 40 (420 μm), ANSI 50 (351 μm), ANSI 60 (264 μm), ANSI 80 (195 μm), ANSI 100 (141 μm), ANSI 120 (116 μm), ANSI 150 (93 μm), ANSI 180 (78 μm), ANSI 220 (66 μm), ANSI 240 (53 μm), ANSI 280 (44 μm), ANSI 320 (46 μm), ANSI 360 (30 μm), ANSI 400 (24 μm), and ANSI 600 (16 μm). Exemplary FEPA grade designations include P12 (1746 μm), P16 (1320 μm), P20 (984 μm), P24 (728 μm), P30 (630 μm), P36 (530 μm), P40 (420 μm), P50 (326 μm), P60 (264 μm), P80 (195 μm), P100 (156 μm), P120 (127 μm), P120 (127 μm), P150 (97 μm), P180 (78 μm), P220 (66 μm), P240 (60 μm), P280 (53 μm), P320 (46 μm), P360 (41 μm), P400 (36 μm), P500 (30 μm), P600 (26 μm), and P800 (22 μm). An approximate average particles size of reach grade is listed in parenthesis following each grade designation.

Shaped abrasive particles 100, 200, 300, 400, 500, or 600 or any crushed abrasive particles further described herein can include any suitable material or mixture of materials. For example, shaped abrasive particles 100, 200, 300, 400, 500, or 600 can include a material chosen from an alpha-alumina, a fused aluminum oxide, a heat-treated aluminum oxide, a ceramic aluminum oxide, a sintered aluminum oxide, a silicon carbide, a titanium diboride, a boron carbide, a tungsten carbide, a titanium carbide, a diamond, a cubic boron nitride, a garnet, a fused alumina-zirconia, a sol-gel derived abrasive particle, a cerium oxide, a zirconium oxide, a titanium oxide, and combinations thereof. In various embodiments, shaped abrasive particles 100, 200, 300, 400, 500, or 600 and crushed abrasive particles can include the same materials. In further embodiments, shaped abrasive particles 100, 200, 300, 400, 500, or 600 and crushed abrasive particles can include different materials.

In addition to the materials already described, at least one magnetic material may be included within or coated to shaped abrasive particle 100, 200, 300, 400, 500, or 600. Examples of magnetic materials include iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (about 85:9:6 by weight) marketed as Sendust alloy; Heusler alloys (e.g., Cu₂MnSn); manganese bismuthide (also known as Bismanol); rare earth magnetizable materials such as gadolinium, dysprosium, holmium, europium oxide, alloys of neodymium, iron and boron (e.g., Nd₂Fe₁₄B), and alloys of samarium and cobalt (e.g., SmCo₅); MnSb; MnOFe₂O₃; Y₃Fe₅O₁₂; CrO₂; MnAs; ferrites such as ferrite, magnetite, zinc ferrite; nickel ferrite; cobalt ferrite, magnesium ferrite, barium ferrite, and strontium ferrite; yttrium iron garnet; and combinations of the foregoing. In various embodiments, the magnetizable material is an alloy containing 8 to 12 weight percent aluminum, 15 to 26 wt % nickel, 5 to 24 wt % cobalt, up to 6 wt % copper, up to 1% titanium, wherein the balance of material to add up to 100 wt % is iron. In some other embodiments, a magnetizable coating can be deposited on an abrasive particle 100 using a vapor deposition technique such as, for example, physical vapor deposition (PVD) including magnetron sputtering.

Including these magnetizable materials can allow shaped abrasive particle 100, 200, 300, 400, 500, or 600 to be responsive to a magnetic field. Any of shaped abrasive particles 100, 200, 300, 400, 500, or 600 can include the same material or include different materials.

Furthermore, some shaped abrasive particles 100, 200, 300, 400, 500, or 600 can include a polymeric material and can be characterized as soft abrasive particles. The low temperature at which the curable resins described herein are cured at, can allow for inclusion of these soft abrasive particles, which may otherwise thermally degrade if exposed to the temperatures required to cure or mold a bonded abrasive article including a phenolic resin binder, vitrified binder, or metallic binder. The soft shaped abrasive particles described herein can independently include any suitable material or combination of materials. For example, the soft shaped abrasive particles can include a reaction product of a polymerizable mixture including one or more polymerizable resins, the one or more polymerizable resins such as a hydrocarbyl polymerizable resin. Examples of such resins include those chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, a drying oil, or mixtures thereof. The polymerizable mixture can include additional components such as a plasticizer, a catalyst, a cross-linker, a surfactant, a mild-abrasive, a pigment, a catalyst and an antibacterial agent.

Where multiple components are present in the polymerizable mixture, those components can account for any suitable weight percentage of the mixture. For example, the polymerizable resin or resins may be in a range of from about 35 wt % to about 99.9 wt % of the polymerizable mixture, about 40 wt % to about 95 wt %, or less than, equal to, or greater than about 35 wt %, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99.9 wt %.

If present, the cross-linker may be in a range of from about 2 wt % to about 60 wt % of the polymerizable mixture, from about 5 wt % to about 10 wt %, or less than, equal to, or greater than about 2 wt %, 3, 4, 5, 6, 7, 8, 9, 10, 11, 12, 13, 14, or about 15 wt %. Examples of suitable cross-linkers include a cross-linker available under the trade designation CYMEL 303 LF, of Allnex USA Inc., Alpharetta, Ga., USA; or a cross-linker available under the trade designation CYMEL 385, of Allnex USA Inc., Alpharetta, Ga., USA.

If present, the mild-abrasive may be in a range of from about 5 wt % to about 65 wt % of the polymerizable mixture, about 10 wt % to about 20 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or about 65 wt %. Examples of suitable mild-abrasives include a mild-abrasive available under the trade designation MINSTRON 353 TALC, of Imerys Talc America, Inc., Three Forks, Mont., USA; a mild-abrasive available under the trade designation USG TERRA ALBA NO. 1 CALCIUM SULFATE, of USG Corporation, Chicago, Ill., USA; Recycled Glass (40-70 Grit) available from ESCA Industries, Ltd., Hatfield, Pa., USA, silica, calcite, nepheline, syenite, calcium carbonate, or mixtures thereof.

If present, the plasticizer may be in a range of from about 5 wt % to about 40 wt % of the polymerizable mixture, about 10 wt % to about 15 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or about 40 wt %. Examples of suitable plasticizers include acrylic resins or styrene butadiene resins. Examples of acrylic resins include an acrylic resin available under the trade designation RHOPLEX GL-618, of DOW Chemical Company, Midland, Mich., USA; an acrylic resin available under the trade designation HYCAR 2679, of the Lubrizol Corporation, Wickliffe, Ohio, USA; an acrylic resin available under the trade designation HYCAR 26796, of the Lubrizol Corporation, Wickliffe, Ohio, USA; a polyether polyol available under the trade designation ARCOL LG-650, of DOW Chemical Company, Midland, Mich., USA; or an acrylic resin available under the trade designation HYCAR 26315, of the Lubrizol Corporation, Wickliffe, Ohio, USA. An example of a styrene butadiene resin includes a resin available under the trade designation ROVENE 5900, of Mallard Creek Polymers, Inc., Charlotte, N.C., USA.

If present, the catalyst may be in a range of from 1 wt % to about 20 wt % of the polymerizable mixture, about 5 wt % to about 10 wt %, or less than, equal to, or greater than about 1 wt %, 2, 3, 4, 5, 6, 7, 8, 9, 10, 11, 12, 13, 14, 15, 16, 17, 18, 19, or about 20 wt %. Examples of suitable catalysts include a solution of aluminum chloride or a solution of ammonium chloride.

If present, the surfactant can be in a range of from about 0.001 wt % to about 15 wt % of the polymerizable mixture, about 5 wt % to about 10 wt %, less than, equal to, or greater than about 0.001 wt %, 0.01, 0.5, 1, 2, 3, 4, 5, 6, 7, 8, 9, 10, 11, 12, 13, 14, or about 15 wt %. Examples of suitable surfactants include a surfactant available under the trade designation GEMTEX SC-85-P, of Innospec Performance Chemicals, Salisbury, N.C., USA; a surfactant available under the trade designation DYNOL 604, of Air Products and Chemicals, Inc., Allentown, Pa., USA; a surfactant available under the trade designation ACRYSOL RM-8W, of DOW Chemical Company, Midland, Mich., USA; or a surfactant available under the trade designation XIAMETER AFE 1520, of DOW Chemical Company, Midland, Mich., USA.

If present, the antimicrobial agent may be in a range of from 0.5 wt % to about 20 wt % of the polymerizable mixture, about 10 wt % to about 15 wt %, or less than, equal to, or greater than about 0.5 wt %, 1, 2, 3, 4, 5, 6, 7, 8, 9, 10, 11, 12, 13, 14, 15, 16, 17, 18, 19, or about 20 wt %. An example of a suitable antimicrobial agent includes zinc pyrithione.

If present, the pigment may be in a range of from about 0.1 wt % to about 10 wt % of the polymerizable mixture, about 3 wt % to about 5 wt %, less than, equal to, or greater than about 0.1 wt %, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, or about 10 wt %. Examples of suitable pigments include a pigment dispersion available under the trade designation SUNSPERSE BLUE 15, of Sun Chemical Corporation, Parsippany, N.J., USA; a pigment dispersion available under the trade designation SUNSPERSE VIOLET 23, of Sun Chemical Corporation, Parsippany, N.J., USA; a pigment dispersion available under the trade designation SUN BLACK, of Sun Chemical Corporation, Parsippany, N.J., USA; or a pigment dispersion available under the trade designation BLUE PIGMENT B2G, of Clariant Ltd., Charlotte, N.C., USA. The mixture of components can be polymerized by curing.

Shaped abrasive particle 100, 200, 300, 400, 500, or 600 can be formed in many suitable manners; for example, shaped abrasive particle 100, 200, 300, 400, 500, or 600 can be made according to a multi-operation process. The process can be carried out using any material or precursor dispersion material. Briefly, for embodiments where shaped abrasive particles 100, 200, 300, 400, 500, or 600 are monolithic ceramic particles, the process can include the operations of making either a seeded or non-seeded precursor dispersion that can be converted into a corresponding ceramic (e.g., a boehmite sol-gel that can be converted to alpha alumina); filling one or more mold cavities having the desired outer shape of shaped abrasive particle 100, 200, 300, 400, 500, or 600 with a precursor dispersion; drying the precursor dispersion to form precursor shaped abrasive particle; removing the precursor shaped abrasive particle 100, 200, 300, 400, 500, or 600 from the mold cavities; calcining the precursor shaped abrasive particle 100, 200, 300, 400, 500, or 600 to form calcined, precursor shaped abrasive particle 100, 200, 300, 400, 500, or 600; and then sintering the calcined, precursor shaped abrasive particle 100, 200, 300, 400, 500, or 600 to form shaped abrasive particle 100, 200, 300, 400, 500, or 600. The process will now be described in greater detail in the context of alpha-alumina-containing shaped abrasive particle 100, 200, 300, 400, 500, or 600. In other embodiments, the mold cavities may be filled with a melamine to form melamine shaped abrasive particles.

The process can include the operation of providing either a seeded or non-seeded dispersion of a precursor that can be converted into ceramic. In examples where the precursor is seeded, the precursor can be seeded with an oxide of an iron (e.g., FeO). The precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the precursor dispersion in various embodiments contains from 30 percent to 50 percent, or 40 percent to 50 percent solids by weight.

Examples of suitable precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area.

The physical properties of the resulting shaped abrasive particle 100, 200, 300, 400, 500, or 600 can generally depend upon the type of material used in the precursor dispersion. As used herein, a “gel” is a three-dimensional network of solids dispersed in a liquid.

The precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of an oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the precursor dispersion can be varied.

The introduction of a modifying additive or precursor of a modifying additive can cause the precursor dispersion to gel. The precursor dispersion can also be induced to gel by application of heat over a period of time to reduce the liquid content in the dispersion through evaporation. The precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the precursor dispersion to produce a more stable hydrosol or colloidal precursor dispersion. Suitable peptizing agents are monoprotic acids or acid compounds such as acetic acid, hydrochloric acid, formic acid, and nitric acid. Multiprotic acids can also be used, but they can rapidly gel the precursor dispersion, making it difficult to handle or to introduce additional components. Some commercial sources of boehmite contain an acid titer (such as absorbed formic or nitric acid) that will assist in forming a stable precursor dispersion.

The precursor dispersion can be formed by any suitable means; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

A further operation can include providing a mold having at least one mold cavity, or a plurality of cavities formed in at least one major surface of the mold. In some examples, the mold is formed as a production tool, which can be, for example, a belt, a sheet, a continuous web, a coating roll such as a rotogravure roll, a sleeve mounted on a coating roll, or a die. In one example, the production tool can include polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one example, the entire tool is made from a polymeric or thermoplastic material. In another example, the surfaces of the tool in contact with the precursor dispersion while the precursor dispersion is drying, such as the surfaces of the plurality of cavities, include polymeric or thermoplastic materials, and other portions of the tool can be made from other materials. A suitable polymeric coating can be applied to a metal tool to change its surface tension properties, by way of example.

A polymeric or thermoplastic production tool can be replicated off a metal master tool. The master tool can have the inverse pattern of that desired for the production tool. The master tool can be made in the same manner as the production tool. In one example, the master tool is made of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities can be from an opening in the top surface or bottom surface of the mold. In some examples, the cavities can extend for the entire thickness of the mold. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make shaped abrasive particle 100. The depth dimension is equal to the perpendicular distance from the top surface to the lowermost point on the bottom surface. The depth of a given cavity can be uniform or can vary along its length and/or width. The cavities of a given mold can be of the same shape or of different shapes.

A further operation involves filling the cavities in the mold with the precursor dispersion (e.g., by a conventional technique). In some examples, a knife roll coater or vacuum slot die coater can be used. A mold release agent can be used to aid in removing the particles from the mold if desired. Examples of mold release agents include oils such as peanut oil or mineral oil, fish oil, silicones, polytetrafluoroethylene, zinc stearate, and graphite. In general, a mold release agent such as peanut oil, in a liquid, such as water or alcohol, is applied to the surfaces of the production tool in contact with the precursor dispersion such that from about 0.1 mg/in² (0.6 mg/cm²) to about 3.0 mg/in² (20 mg/cm²), or from about 0.1 mg/in² (0.6 mg/cm²) to about 5.0 mg/in² (30 mg/cm²), of the mold release agent is present per unit area of the mold when a mold release is desired. In various embodiments, the top surface of the mold is coated with the precursor dispersion. The precursor dispersion can be pumped onto the top surface.

In a further operation, a scraper or leveler bar can be used to force the precursor dispersion fully into the cavity of the mold. The remaining portion of the precursor dispersion that does not enter the cavity can be removed from the top surface of the mold and recycled. In some examples, a small portion of the precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the precursor dispersion extends substantially beyond the top surface.

In those examples where it is desired to have the exposed surfaces of the cavities result in planar faces of the shaped abrasive particles, it can be desirable to overfill the cavities (e.g., using a micronozzle array) and slowly dry the precursor dispersion.

A further operation involves removing the volatile component to dry the dispersion. The volatile component can be removed by fast evaporation rates. In some examples, removal of the volatile component by evaporation occurs at temperatures above the boiling point of the volatile component. An upper limit to the drying temperature often depends on the material the mold is made from. For polypropylene tool, the temperature should be less than the melting point of the plastic. In one example, for a water dispersion of from about 40 to 50 percent solids and a polypropylene mold, the drying temperatures can be from about 90° C. to about 165° C., or from about 105° C. to about 150° C., or from about 105° C. to about 120° C. Higher temperatures can lead to improved production speeds but can also lead to degradation of the polypropylene tool, limiting its useful life as a mold.

During drying, the precursor dispersion shrinks, often causing retraction from the cavity walls. For example, if the cavities have planar walls, then the resulting shaped abrasive particle 100 can tend to have at least three concave major sides. It is presently discovered that by making the cavity walls concave (whereby the cavity volume is increased) it is possible to obtain shaped abrasive particle 100, 200, 300, 400, 500, or 600 that have at least three substantially planar major sides. The degree of concavity generally depends on the solids content of the precursor dispersion.

A further operation involves removing resultant precursor shaped abrasive particle 100, 200, 300, 400, 500, or 600 from the mold cavities. The precursor shaped abrasive particle 100, 200, 300, 400, 500, or 600 can be removed from the cavities by using the following processes alone or in combination on the mold: gravity, vibration, ultrasonic vibration, vacuum, or pressurized air to remove the particles from the mold cavities.

The precursor shaped abrasive particle 100, 200, 300, 400, 500, or 600 can be further dried outside of the mold. If the precursor dispersion is dried to the desired level in the mold, this additional drying step is not necessary. However, in some instances it can be economical to employ this additional drying step to minimize the time that the precursor dispersion resides in the mold. The precursor shaped abrasive particle 100, 200, 300, 400, 500, or 600 will be dried from 10 to 480 minutes, or from 120 to 400 minutes, at a temperature from 50° C. to 160° C., or 120° C. to 150° C.

A further operation involves calcining the precursor shaped abrasive particle 100, 200, 300, 400, 500, or 600. During calcining, essentially all the volatile material is removed, and the various components that were present in the precursor dispersion are transformed into metal oxides. The precursor shaped abrasive particle 100, 200, 300, 400, 500, or 600 is generally heated to a temperature from 400° C. to 800° C. and maintained within this temperature range until the free water and over 90 percent by weight of any bound volatile material are removed. In an optional step, it can be desirable to introduce the modifying additive by an impregnation process. A water-soluble salt can be introduced by impregnation into the pores of the calcined, precursor shaped abrasive particle 100, 200, 300, 400, 500, or 600. Then the precursor shaped abrasive particle 100, 200, 300, 400, 500, or 600 are pre-fired again.

A further operation can involve sintering the calcined, precursor shaped abrasive particle 100, 200, 300, 400, 500, or 600 to form particles 100, 200, 300, 400, 500, or 600. In some examples where the precursor includes rare earth metals, however, sintering may not be necessary. Prior to sintering, the calcined, precursor shaped abrasive particle 100, 200, 300, 400, 500, or 600 are not completely densified and thus lack the desired hardness to be used as shaped abrasive particle 100, 200, 300, 400, 500, or 600. Sintering takes place by heating the calcined, precursor shaped abrasive particle 100, 200, 300, 400, 500, or 600 to a temperature of from 1000° C. to 1650° C. The length of time for which the calcined, precursor shaped abrasive particle 100, 200, 300, 400, 500, or 600 can be exposed to the sintering temperature to achieve this level of conversion depends upon various factors, but from five seconds to 48 hours is possible.

In another embodiment, the duration of the sintering step ranges from one minute to 90 minutes. After sintering, shaped abrasive particle 100, 200, 300, 400, 500, or 600 can have a Vickers hardness of 10 GPa (gigaPascals), 16 GPa, 18 GPa, 20 GPa, or greater. Additional operations can be used to modify the described process, such as, for example, rapidly heating the material from the calcining temperature to the sintering temperature and centrifuging the precursor dispersion to remove sludge and/or waste. Moreover, the process can be modified by combining two or more of the process steps if desired.

The bonded abrasive article precursor can be cured to form a bonded abrasive article. FIGS. 7 and 8 show an embodiment of bonded abrasive article 700. Specifically, FIG. 7 is a perspective view of bonded abrasive article 700 and FIG. 8 is a sectional view of bonded abrasive article 700 taken along line 2-2 of FIG. 7. FIGS. 7 and 8 show many of the same features and are discussed concurrently. As depicted, bonded abrasive article 700 is a depressed center grinding wheel. In other embodiments, the bonded abrasive article can be a cut-off wheel, cutting wheel, a cut-and-grind wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, or a double disk grinding wheel. The dimensions of the wheel can be any suitable size; for example, the diameter can range from 2 mm to about 2000 mm, about 100 mm to about 500 mm, less than, equal to, or greater than about 2 mm, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840,850, 860, 870, 880, 890, 900, 910, 920, 930, 940, 950, 960, 970, 980, 990, 1000, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, 1650, 1660, 1670, 1680, 1690, 1700, 1710, 1720, 1730, 1740, 1750, 1760, 1770, 1780, 1790, 1800, 1810, 1820, 1830, 1840, 1850, 1860, 1870, 1880, 1890, 1900, 1910, 1920, 1930, 1940, 1950, 1960, 1970, 1980, 1990, or about 2000 mm.

Bonded abrasive article 700 includes first major surface 702 and second major surface 702. First major surface 702 and second major surface 702 have a substantially circular profile. Central aperture 716 extends between first major surface 702 and second major surface 702 and can be used, for example, for attachment to a power-driven tool. In examples of other abrasive articles, central aperture 716 can be designed to only extend partially between first and second major surfaces 702 and 704.

As shown, shaped abrasive particles 100 are attached to reinforcing component 705 and arranged in layers. Although shaped abrasive particles 100 are shown, it is possible for bonded abrasive article 700 to include any of the other shaped or conventional abrasive particles described herein. Additionally, although shaped abrasive particles 100 are shown attached to reinforcing component 705, in various embodiments, bonded abrasive article 700, may be free of any reinforcing component 705. Additionally, the cured composition may be degraded during curing, leaving only shaped abrasive particles 100. Where present, reinforcing layer 705 can include a polymeric film, a metal foil, a woven fabric, a knitted fabric, paper, vulcanized fiber, a staple fiber, a continuous fiber, a nonwoven, a foam, a screen, a laminate, and combinations thereof.

As shown in FIGS. 7 and 8, bonded abrasive article 700 includes first layer of abrasive particles 712 and second layer of abrasive particles 714. First layer of abrasive particles 712 and second layer of abrasive particles 714 are spaced apart from one another with the binder located therebetween. The binder is the cured epoxy, polyurethane, or polyacrylate network. Although two layers of abrasive particles 100 are shown, bonded abrasive article 700 can include additional layers of abrasive particles. For example, bonded abrasive article 700 can include a third layer of abrasive particles adjacent to at least one of first or second layers of abrasive particles 712 and 714.

As shown, at least a majority of the abrasive particles 100 are not randomly distributed within first and second layers 712 and 714. Rather, abrasive particles 100 are distributed according to a predetermined pattern. For example, FIG. 8 shows a pattern where adjacent abrasive particles 100 of first layer of abrasive particles 712 are directly aligned with each other in rows extending from central aperture 716 to the perimeter of bonded abrasive article 700. The adjacent abrasive particles are also directly aligned in concentric circles.

Abrasive particles 100 in each layer do not have to be the same abrasive particle. For example, first layer of abrasive particles 712 can include at least a first plurality of abrasive particles 100 and a second plurality of abrasive particles 100. The first plurality of abrasive particles 100 and the second plurality of abrasive particles 100 can individually range from about from about 10 wt % to about 100 wt % of the first layer of abrasive particles 712, or from about 20 wt % to about 90 wt %, or from about 30 wt % to about 80 wt %, or from about 40 wt % to about 60 wt %, or less than about, equal to about, or greater than about 15 wt %, 20, 25, 30, 35, 40, 45, 50, 55, 60, 65, 70, 75, 80, 85, 90, or 95 wt %.

In still further embodiments, bonded abrasive article 700 may only include first layer of abrasive particles 712, but instead of being a planar layer, layer 712 can conform to a helical shape centered about a z-axis and extending from first major surface 702 to second surface 704.

As shown in FIGS. 7 and 8, each of the plurality of shaped abrasive particles 100 can have a specified z-direction rotational orientation about a z-axis passing through individual shaped abrasive particles 100 and through reinforcing component 705 at a 90 degree angle to reinforcing component 705. Shaped abrasive particles 100 are orientated with a surface feature, such as a substantially planar surface of particle 100, rotated into a specified angular position about the z-axis. The specified z-direction rotational orientation occurs more frequently than would occur by a random z-directional rotational orientation of the surface feature due to electrostatic coating or drop coating of shaped abrasive particles 100, 200, 300, 400, 500, or 600 when forming bonded abrasive article precursor. As such, by controlling the z-direction rotational orientation of a significantly large number of shaped abrasive particles 100, the cut rate, finish, or both of a resulting bonded abrasive article to which bonded abrasive article precursor is applied can be varied from those manufactured using an electrostatic coating method. In various embodiments, at least 50, 51, 55, 60, 65, 70, 75, 80, 85, 90, 95, or 99 percent of shaped abrasive particles 100 can have a specified z-direction rotational orientation which does not occur randomly and which can be substantially the same for all of the aligned particles. In other embodiments, about 50 percent of shaped abrasive particles 100 can be aligned in a first direction and about 50 percent of shaped abrasive particles 100 can be aligned in a second direction. In one embodiment, the first direction is substantially orthogonal to the second direction.

Abrasive particles 100 of the first and second pluralities of particles can differ in respect to the shape, size, or type of abrasive particle 100. For example, the first plurality of abrasive particles can be shaped abrasive particles whereas the second plurality of abrasive particles can be crushed abrasive particles. In other embodiments, the first and second pluralities of abrasive particles 100 can be a same type of abrasive particle 100 (e.g., a shaped abrasive particle) but may differ in size. In further embodiments, the first and second pluralities of particles may be different types of abrasive particles but may have substantially the same size. The second, third, and any additional layers of abrasive particles can include pluralities of abrasive particles that are similar to those of the first layer of abrasive particles.

According to various embodiments, about 80 wt % to about 100 wt % of the reactants (e.g., the curable resins) of the bonded abrasive article precursor can be polymerized, about 99.9 wt % to about 95 wt %, less than, equal to, or greater than about 80 wt %, 81, 82, 83, 84, 85, 86, 87, 88, 89, 90, 91, 92, 93, 94, 95, 96, 97, 98, 99, or about 100 wt %. The extent to which the reactants are polymerized can be measured using differential scanning calorimetry to determine the % cure. According to various embodiments, % cure=[1−(ΔH/ΔH₀)]*100, where ΔH₀ is the cure exotherm of the uncured reactants. The % cure can be in a range of from about 80% to about 100%, about 90% to about 95%, less than, equal to, or greater than about 80%, 81, 82, 83, 84, 85, 86, 87, 88, 89, 90, 91, 92, 93, 94, 95, 96, 97, 98, 99, or about 100%. In various embodiments, the polymerization reaction is not a condensation reaction and water, therefore, accounts for less than about 2 wt %, 1.5, 1, or 0.5 wt % of bonded abrasive article 700.

Bonded abrasive article 700 can be formed according to many suitable methods. For example, the curable composition can be placed in a mold having a shape corresponding to the final shape of the desired bonded abrasive article. The curable composition can then be cured directly by exposing the curable composition to an appropriate temperature for a set amount of time. However, this may not make it possible to form a bonded abrasive article where abrasive particles 100, for example, are precisely arranged. If a precise arrangement is desired, an apparatus such as apparatus 800 may be used.

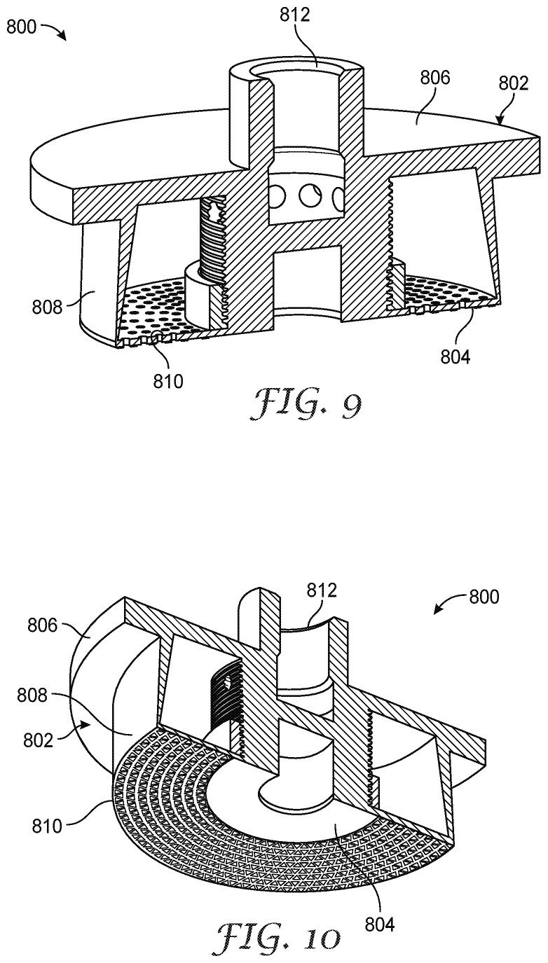

FIGS. 8 and 9 are discussed concurrently. As shown, apparatus 800 includes housing 802. Housing 802 is formed from housing first major surface 804 and opposed housing second major surface 806. Housing first major surface 804 and housing second major surface 806 are connected by housing peripheral surface 808.

Apparatus first major surface 804 has a substantially planar profile and includes a plurality of holes 810 extending therethrough. Each hole 810 is adapted to receive an abrasive particle. At least some of holes 810 are further arranged on apparatus first major surface 804 in a pattern. The pattern can correspond to, for example, the predetermined pattern of the abrasive particles of bonded abrasive article precursor. In some examples, holes 810 can be randomly arranged. In still other examples, at least some of holes 810 can be arranged in a pattern, whereas other holes are randomly arranged.

The type of abrasive particle that hole 810 receives is a function of the size (e.g., width) and shape of each hole 810. Each hole 810 can receive particles that have a width smaller than the width of hole 810. This provides a first screening feature to help ensure that only desired abrasive particles are received by holes 810. A second screening feature is the shape of hole 810.

Holes 810 can have any suitable polygonal shape. For example, the polygonal shape can be substantially triangular, circular, rectangular, pentagonal, substantially hexagonal, and so forth. These shapes can be adapted to receive specific shaped abrasive particles. For example, if hole 810 is triangularly shaped, it may be best suited to receive a triangularly shaped abrasive particle. Due to the triangular shape, a square shaped abrasive particle will not fit in hole 810 (provided that the particle has a larger width than the hole). Thus, the shape of hole 810 in combination with the width can control the type of abrasive particle that is received.

In some examples, each of holes 810 can be in the shape of an equilateral triangular hole. A length of each side can range from about 0.5 mm to about 3 mm, or about 1 mm to about 1.5 mm, or less than about, equal to about, or greater than about 1 mm, 1.5 mm, 2 mm, or about 2.5 mm. An angle of a sidewall of each hole 810 may range from about 80 degrees to about 105 degrees relative to the bottom of each hole, or about 95 degrees to about 100 degrees, or less than about, equal to about, or greater than about 85 degrees, 90, 95, or 100 degrees. The depth of each hole may range from about 0.10 mm to about 0.50 mm, or about 0.20 mm to about 0.30 mm or less than about, equal to about, or greater than about 0.15 mm, 0.20, 0.25, 0.30, 0.35, 0.40, or 0.45 mm.

In addition to having regular shaped holes 810, apparatus 800 can have irregular shaped holes. That is, the shape of holes 810 can be designed to substantially match the shape of crushed abrasive particles. While great variety in the dimensions of holes 810 is possible, each hole can also be designed to have substantially the same size. This configuration may be desirable for applications in which each abrasive particle has the same size.

Holes 810 can be further shaped to have a smaller width on one end of hole 810 than on the other end. That is, the width of hole 810 at apparatus first major surface 804 can be wider than that of the internal end of hole 810. For example, the width of hole 810 at the first end can range from about 1.1 to about 4 times larger than the width of the hole at the second end, or about 2 to about 3 times larger, or less than about, equal to, or greater than about 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, or 4.9 times larger than the width of hole 810 at the second end. This way the abrasive particle will not pass completely through hole 804 and into housing 802. The interior of the holes 810 can also be sloped. This can allow for a specific orientation of shaped abrasive particles within hole 810. For example, some abrasive particles may have sloped sidewalls. The interior of holes 810 may in turn be sloped to match the sidewalls of the abrasive particles.

In some examples of apparatus 800, apparatus first major surface 804 can be releasably secured to housing 802. This can allow the apparatus to have interchangeable apparatus first surfaces. Each apparatus first surface can have differently sized holes or patterns of holes 810. Thus, apparatus 800 can be very versatile in terms of the types of abrasive particles that it may receive as well as the patterns it can create.

Apparatus 800 can releasably secure the abrasive particles in any number of sufficient ways. For example, as shown, housing 802 includes inlet 812 located on opposed housing second major surface 806. Inlet 812 can be adapted to be connected to a vacuum generation system. In operation, a low pressure (e.g., vacuum-like) environment can be created within housing 802. Thus, any abrasive particles disposed within the holes 810 are retained therein by suction. To release the abrasive particles, the vacuum generation system is turned off, thus resulting in a loss of suction. Alternatively, a magnet can be disposed within housing 802 that can be selectively engaged or disengaged. If the abrasive particles have metal in or on them, respectively, then they may be attracted to the magnet and drawn to the holes.

As stated herein bonded abrasive articles 700, according to the present disclosure, can be made according to any suitable method. One method includes retaining a first plurality of abrasive particles within a first portion of the plurality of holes of the apparatus described herein. The apparatus can be positioned within a mold and a plurality of abrasive particles can be released in the mold and optionally contacting with reinforcing component 705. Components of the curable composition such as the curable resins and the curative components are then deposited to form the curable composition. The mold can then be heated, if necessary to begin or increase the rate of curing of the curable composition to form boned abrasive article.

If multiple layers of abrasive particles are desired, then multiple layers of abrasive particles can be deposited in the curable composition before curing. Furthermore, prior to curing, if any of the shaped abrasive particles are responsive to a magnetic field, the orientation of the shaped abrasive particles can be controlled or tuned by exposing them to a magnetic field and rotating them with the magnetic field.

In various embodiments, bonded abrasive article 700 may act as a transfer tool to form a bonded abrasive article comprising a resinous, vitrified, or metallic binder. For example, bonded abrasive article 700, having shaped abrasive particles 100 arranged according to a predetermined pattern may be placed in a mold and a polymeric resin binder in the mold and cured to form a resin bonded, vitrified, or metallic bonded abrasive article. During curing the temperature may be high enough to thermally degrade the cured network or bonded abrasive article 700, leaving shaped abrasive particles 100 arranged according to a predetermined pattern in the phenolic resin bond, vitrified binder, or metallic binder system. This can be a helpful way to form bonded abrasive articles having shaped abrasive particles arranged according to a predetermined pattern.

According to further embodiments a bonded abrasive article can be formed that includes alternating layers of materials. For example, a first layer can include an epoxy resin whereas a second layer can include a phenolic resin. As another example the first layer and second layer may differ by the type of abrasive article that is included in each layer. In a multi-layer construction, the bonded abrasive article may include 2 layers, 4 layers, 6 layers, or any plural number of layers.

Useful phenolic resins include novolac and resole phenolic resins. Novolac phenolic resins are characterized by being acid-catalyzed and as having a ratio of formaldehyde to phenol of less than one, for example, between 0.5:1 and 0.8:1. Resole phenolic resins are characterized by being base catalyzed and having a ratio of formaldehyde to phenol of greater than or equal to one, for example from 1:1 to 3:1. Novolac and resole phenolic resins may be chemically modified (e.g., by reaction with epoxy compounds), or they may be unmodified. Exemplary acidic catalysts suitable for curing phenolic resins include sulfuric, hydrochloric, phosphoric, oxalic, and p-toluenesulfonic acids. Alkaline catalysts suitable for curing phenolic resins include sodium hydroxide, barium hydroxide, potassium hydroxide, calcium hydroxide, organic amines, or sodium carbonate.

Phenolic resins can be available from commercial sources. Examples of commercially available novolac resins include DUREZ 1364, a two-step, powdered phenolic resin (marketed by Durez Corporation, Addison, Tex., under the trade designation VARCUM (e.g., 29302), or DURITE RESIN AD-5534 (marketed by Hexion, Inc., Louisville, Ky.). Examples of commercially available resole phenolic resins useful in practice of the present disclosure include those marketed by Durez Corporation under the trade designation VARCUM (e.g., 29217, 29306, 29318, 29338, 29353); those marketed by Ashland Chemical Co., Bartow, Fla. under the trade designation AEROFENE (e.g., AEROFENE 295); and those marketed by Kangnam Chemical Company Ltd., Seoul, South Korea under the trade designation “PHENOLITE” (e.g., PHENOLITE TD-2207).

With regards to vitrified binding materials, vitreous bonding materials, which exhibit an amorphous structure and are hard, are well known in the art. In some cases, the vitreous bonding material includes crystalline phases. Examples of metal oxides that are used to form vitreous bonding materials include: silica, silicates, alumina, soda, calcia, potassia, titania, iron oxide, zinc oxide, lithium oxide, magnesia, boria, aluminum silicate, borosilicate glass, lithium aluminum silicate, combinations thereof, and the like. Vitreous bonding materials can be formed from a composition comprising from 10 to 100% glass frit, although more typically the composition comprises 20% to 80% glass frit, or 30% to 70% glass frit. The remaining portion of the vitreous bonding material can be a non-frit material. Alternatively, the vitreous bond may be derived from a non-frit containing composition. Vitreous bonding materials are typically matured at a temperature(s) in the range from about 700° C. to about 1500° C., usually in the range from about 800° C. to about 1300° C., sometimes in the range from about 900° C. to about 1200° C., or even in the range from about 950° C. to about 1100° C. The actual temperature at which the bond is matured depends, for example, on the particular bond chemistry. Preferred vitrified bonding materials may include those comprising silica, alumina (preferably, at least 10 percent by weight alumina), and boria (preferably, at least 10 percent by weight boria). In most cases the vitrified bonding materials further comprise alkali metal oxide(s) (e.g., Na₂O and K₂O) (in some cases at least 10 percent by weight alkali metal oxide(s)).

### EXAMPLES

Various embodiments of the present disclosure can be better understood by reference to the following Examples which are offered by way of illustration. The present disclosure is not limited to the Examples given herein.

Materials

| Abbreviation | Material |
|---|---|
| PSG | Precisely-shaped alpha alumina abrasive |
| | particles prepared according to the |
| | disclosure of U.S. Pat. No. US |
| | 2015/0267097 Al (Rosenflanz et al.) by |
| | molding a slurry comprising non-colloidal |
| | solid particles and a liquid vehicle in |
| | equilateral triangular polypropylene mold |
| | cavities. Triangle edge length was ~1.3 |
| | mm with a thickness of ~0.3 mm. |
| 36 SiC | A 36-grit abrasive particle available from |
| | Washington Mills, North Grafton, MA, |
| | under the trade designation 15C-36 |
| 46 AO | A 46-grit fused aluminum oxide available |
| | from Imerys, Bahrain, under the trade |
| | designation Alodur FRSCC-46 |
| 400 AO | A 400-grit fused aluminum oxide available |
| | from Imerys, Bahrain, under the trade |
| | designation Alodur ZWSK F400 |
| WA1 | A liquid epoxy novolac resin available |
| | from Huntsman, Houston TX, available |
| | under the trade designation Araldite |
| | EPN-1179 |
| WA2 | A solid epoxy cresol novolac available |
| | from Huntsman, Houston TX, under the |
| | trade designation Araldite ECN-1273 |
| CAT | An antimony hexafluoride-based catalyst |
| | available from King Industries Norwalk, |
| | CT, under the trade designation K-PURE |
| | CXC-1612 |
| PAF | Potassium Aluminum Fluoride obtained |
| | from Washington Mills under the trade |
| | name PAF |
| Phenolic Resin Powder | A phenolic resin powder available from |
| | Hexion, Houston, TX under the trade |
| | designation Bakelite 0224SP |
| Furfural | 2-furaldehyde available from Aldrich, St. |
| | Louis, MO |
| Carbon Black | Luvomaxx LB/S |

Bonded abrasive articles of Example 1, Example 2, and Comparative Example 1 were formed to have an outer diameter (OD) of 125 mm, an inner diameter (ID) of 22.2 mm, and a thickness of 1.8 mm. Materials and methods for forming Example 1, Example 2, Example 3, and Comparative Example 1 are described below.

### Example 1

Table 1 lists the materials and amounts used in for Example 1. PSG, 36 SiC, and 46 AO were mixed with WA2 for 7 minutes in a Kitchen Aid Mixer. Separately, Solid Epoxy was ground into microparticles using a coffee grinder. Then WA1 and CAT were added to the PSG, 36 SiC, and 46 AO and mixed for 7 minutes in a Kitchen Aid mixer (Professional 5 Series Mixer). The mix was first screened in an oven at 130° C. and was found to cure into a solid block within less than 5 minutes.

40 g of the cured material was deposited into a mold conforming to the dimensions of the final bonded abrasive article. The mold was closed with a force of 10 tons applied at a temperature of 150° C. for 10 minutes. After heating and cooling back to near ambient temperature, the material was a consolidated solid indicating cure of the epoxy novolac resin. Differential scanning calorimetry (Table 5) confirmed that the residual cure exotherm was negligible.

TABLE 1
Components of the bonded abrasive article
precursor and article of Example 1

| Material | Amount (g) | Wt % |
|---|---|---|
| PSG | 357.1 | 17.9 |
| 36 SiC | 581.6 | 29.1 |
| 46 AO | 723.4 | 36.2 |
| WA2 | 297.1 | 14.9 |
| WA1 | 40.9 | 2.0 |
| CAT | 6.76 | 0.34 |

### Example 2

A powdered pre-mix (Table 2) was first mixed in a food processor for 5 minutes. Then WA1 was mixed into PSG and 46 AO for 7 minutes in a Kitchen Aid mixer, followed by addition of the powdered premix and an initial 7-minute mixing step in the Kitchen Aid mixer. All components were mixed in the proportions shown in Table 3. The mix was first screened in an oven at 130° C. and was found to cure into a solid block within less than 5 minutes.

40 g of the cured material was deposited into a mold conforming to the dimensions of the final bonded abrasive article. The mold was closed with a force of 10 tons applied at a temperature of 150° C. for 10 minutes. After heating and cooling back to near ambient temperature, the material was a consolidated solid indicating cure of the epoxy novolac resin. Differential scanning calorimetry (Table 5) confirmed that the residual cure exotherm was negligible.

TABLE 2
Powdered pre-mix for the bonded abrasive
article precursor of Example 2

| Material | Amount (g) | Wt % |
|---|---|---|
| WA2 | 149.2 | 37.9 |
| PAF | 205.4 | 52.1 |
| 400 AO | 32.3 | 8.2 |
| Carbon Black | 3 | 0.8 |
| CAT | 4 | 1 |

TABLE 3
Components of the bonded abrasive article
precursor and article of Example 2

| Material | Amount (g) | Wt % |
|---|---|---|
| PSG | 206 | 20.80 |
| 46 AO | 433 | 43.60 |
| WA1 | 28 | 2.80 |
| Powdered pre-mix | 325 | 32.80 |

### Example 3

A layered abrasive article was formed by taking material from Example 1 and Comparative Example 1 and stacking each material for form six alternative layers. The total thickness was 11 mm and the construction was cured for 10 minutes at 150° C., followed by a post-cure of 25 hours at 190° C. A total of 6 layers were deposited, and the final wheel thickness was 10 mm.

### Comparative Example 1

Table 4 lists the materials and amounts used in for Comparative Example 1. PSG, 36 SiC, and 46 AO were mixed with Phenolic Resin Powder and Furfural for 7 minutes in a Kitchen Aid Mixer.

40 g of the material was deposited into a mold conforming to the dimensions of the final bonded abrasive article. The mold was closed with a force of 10 tons applied at a temperature of 150° C. for 10 minutes. After heating and cooling back to near ambient temperature, the material was a soft solid. This soft solid material was analyzed using differential scanning calorimetry (Table 5). The results of the differential scanning calorimetry analysis for comparative example 1 with the two temperature setpoints are found in Table 5. The results showed that an amount of phenolic/furfural cure has occurred in CE1 after 10 minutes at 150° C., but the full cure of the phenolic resin—which typically takes place at 190° C. was not complete.

TABLE 4
Components of the bonded abrasive article precursor
and article of Comparative Example 1

| Material | Amount (g) | Wt % |
|---|---|---|
| PSG | 357 | 17.9 |
| 36 SiC | 582 | 29.1 |
| 46 AO | 723 | 36.2 |
| Phenolic Resin Powder | 317 | 21 |
| Furfural | 21 | 1 |

### Differential Scanning Calorimetry

A Q2000 differential scanning calorimetry machine (TA Instruments) was used to measure the exotherm of the bonded abrasive article of Example 1, Example 2, and Comparative Example 1 before curing and after exposure to the maximum temperature of about 150° C. for 10 minutes. Approximately 10 mg of solid material from each example was collected in a pan and weighed. The material was heated at a ramp rate of 10° C./min from 30° C. to 300° C. and the heat flow was measured relative to an empty reference pan. The cure exotherm (ΔH) was defined as the total integrated area under the curve of the heat flow vs. temperature.

Table 5 shows the exotherm, ΔH₀ (J/g) of virgin material prior heating, the exotherm after heating, ΔH_{F} (J/g) to 150° C. for 10 minutes, and the degree of cure after heating to 150° C. for 10 minutes. The degree of cure was defined as:

$$Degree of Cure ( \% ) = 100 \times [ 1 - ( \frac{Δ {H}_{F}}{Δ {H}_{0}} ) ]$$

TABLE 5
Cure exotherm before and after heating to 150° C. for 10 minutes

| | | | Exotherm ΔH_{F} | |
|---|---|---|---|---|
| | Maximum | Exotherm ΔH₀ | (J/g) following | Degree of Cure |
| | Temperature | (J/g) prior to | exposure to 150° C. | (%) after 10 min |
| Example | (° C.) | curing | for 10 minutes | @ 150° C. |
| Ex 1 | 150 | 27.1 | 0 | ~100% |
| Ex 2 | 150 | 17.1 | 0 | ~100% |
| CE 1 | 150 | 38.8 | 5.8 | 85% |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

provides a bonded abrasive article precursor comprising

a curable composition comprising:
a curative component; and
one or more resins, wherein the curable composition is curable in an amount of time in a range of from about 0.1 minutes to about 20 minutes at a temperature of about 25° C. to about 160° C.; and

a plurality of abrasive particles dispersed in the curable composition.

Embodiment 2 provides the bonded abrasive article precursor of Embodiment 1, wherein the curative component is in a range of from about 0.1 wt % to about 40 wt % of the curable composition.

Embodiment 3 provides the bonded abrasive article precursor of any one of Embodiments 1 or 2, wherein the curative component is in a range of from about 0.1 wt % to about 10 wt % of the curable composition.

Embodiment 4 provides the bonded abrasive article of any one of Embodiments 1-3, wherein curative component comprises an acid catalyst, a base catalyst, an amphoteric catalyst, an aliphatic polyamine, an aromatic polyamine, an aromatic polyamide, an alicyclic polyamine, a polyamine, a polyamide, an amino resin, a 9,9-bis(aminophenyl)fluorene, a polyisocyanate, a polyol chain extender, imidazole, a dicyandiamide, or a mixture thereof.

Embodiment 5 provides the bonded abrasive article precursor of Embodiment 4, wherein the acid catalyst comprises antimony hexafluoride, a diazonium salt, an idonium salt, a sulfonium salt, a ferrocenium salt, or a mixture thereof.

Embodiment 6 provides the bonded abrasive article precursor of any one of Embodiments 4 or 5, wherein the base catalyst comprises an imidazole, a dicyandiamide an amine-functional catalyst, or a mixture thereof.

Embodiment 7 provides the bonded abrasive article precursor of any one of Embodiments 4-6, wherein the 9,9-bis(aminophenyl)fluorene compound is chosen from 9,9-bis(4-aminophenyl)fluorene, 4-methyl-9,9-bis(4-aminophenyl)fluorene, 4-chloro-9,9-bis(4-aminophenyl)fluorene, 2-ethyl-9,9-bis(4-aminophenyl)fluorene, 2-iodo-9,9-bis(4-aminophenyl)fluorene, 3-bromo-9,9-bis(4-aminophenyl)fluorene, 9-(4-methylaminophenyl)-9-(4-ethylaminophenyl)fluorene, 1-chloro-9,9-bis(4-aminophenyl)fluorene, 2-methyl-9,9-bis(4-aminophenyl)fluorene, 2,6-dimethyl-9,9-bis(4-aminophenyl)fluorene, 1,5-dimethyl-9,9-bis(4-aminophenyl)fluorene, 2-fluoro-9,9-bis(4-aminophenyl)fluorene, 1,2,3,4,5,6,7,8-octafluoro-9,9-bis(4-aminophenyl)fluorene, 2,7-dinitro-9,9-bis(4-aminophenyl)fluorene, 2-chloro-4-methyl-9,9-bis(4-aminophenyl)fluorene, 2,7-dichloro-9,9-bis(4-aminophenyl)fluorene, 2-acetyl-9,9-bis(4-aminophenyl)fluorene, 2-methyl-9,9-bis(4-methylaminophenyl)fluorene, 2-chloro-9,9-bis(4-ethylaminophenyl)fluorene, 2-t-butyl-9,9-bis(4-methylaminophenyl)fluorene, 9,9-bis(3-methyl-4-aminophenyl)fluorene, 9-(3-methyl-4-aminophenyl)-9-(3-chloro-4-aminophenyl)fluorene, 9-bis(3-methyl-4-aminophenyl)fluorene, 9,9-bis(3-ethyl-4-aminophenyl)fluorene, 9,9-bis(3-phenyl-4-aminophenyl)fluorene, 9,9-bis(3,5-dimethyl-4-methylaminophenyl)fluorene, 9,9-bis(3,5-dimethyl-4-aminophenyl)fluorene, dimethyl-4-methylaminophenyl)-9-(3,5-dimethyl-4-aminophenyl)fluorene, 9-(3,5-diethyl-4-aminophenyl)-9-(3-methyl-4-aminophenyl)fluorene, 1,5-dimethyl-9,9-bis(3,5-dimethyl-4-methylaminophenyl)fluorene, 9,9-bis(3,5-diisopropyl-4-aminophenyl)fluorene, 9,9-bis(3-chloro-4-aminophenyl)fluorene, 9,9-bis(3,5-dichloro-4-aminophenyl)fluorene, 9,9-bis(3,5-diethyl-4-methylaminophenyl)fluorene, 9,9-bis(3,5-diethyl-4-aminophenyl)fluorene, and a mixture thereof.

Embodiment 8 provides the bonded abrasive article precursor of any one of Embodiments 4-7, wherein the polyisocyanate is chosen from dicyclohexylmethane-4,4′-diisocyanate, isophorone diisocyanate,

Embodiment 9 provides the bonded abrasive article precursor of any one of Embodiments 4-8, wherein the polyol chain extender is chosen from ethylene glycol, a poly(ethylene glycol), diethylene glycol, triethylene glycol, tetraethylene glycol, propylene glycol, a poly(propylene glycol), dipropylene glycol, tripropylene glycol, 1,3-propanediol, 1,3-butanediol, 1,4-butanediol, neopentyl glycol, 1,6-hexanediol, 1,4-cyclohexanedimethanol, or a mixture thereof.

Embodiment 10 provides the bonded abrasive article precursor of any one of Embodiments 1-9, wherein the one or more resins are in a range of from about 20 wt % to about 99.9 wt % of the curable composition.

Embodiment 11 provides the bonded abrasive article precursor of any one of Embodiments 1-10, wherein the one or more resins are in a range of from about 25 wt % to about 70 wt % of the curable composition.

Embodiment 12 provides the bonded abrasive article precursor of any one of Embodiments 1-11, wherein the one or more resins comprise an epoxy resin, an acrylated epoxy resin, a polyester polyol, a polyisocyante, a polyol, or a mixture thereof.

Embodiment 13 provides the bonded abrasive article precursor of Embodiment 12, wherein the one or more epoxy resins are chosen from a diglycidyl ether of bisphenol F, a low epoxy equivalent weight diglycidyl ether of bisphenol A, a liquid epoxy novolac, a liquid aliphatic epoxy, a liquid cycloaliphatic epoxy, a 1,4-cyclohexandimethanoldiglycidylether, 3,4-epoxycyclohexylmethyl-3,4-epoxycyclohexane carboxylate, tetraglycidylmethylenedianiline, N,N,N′,N′-tetraglycidyl-4,4′-methylenebisbenzenamine, a triglycidyl of para-aminophenol, N,N,N′,N′-tetraglycidyl-m-xylenediamine, and a mixture thereof.

Embodiment 14 provides the bonded abrasive article precursor of any one of Embodiments 12 or 13, wherein the acrylated epoxy resin comprises:

a tetrahydrofurfuryl (THF) (meth)acrylate copolymer component;

one or more of the epoxy resins; and

one or more hydroxy-functional polyethers.

Embodiment 15 provides the bonded abrasive article precursor of Embodiment 14, wherein the THF (meth)acrylate copolymer component comprises one or more THF (meth)acrylate monomers, one or more (meth)acrylate ester monomers, and one or more optional cationically reactive functional (meth)acrylate monomers.

Embodiment 16 provides the bonded abrasive article precursor of any one of Embodiments 14 or 15, wherein the THF (meth)acrylate copolymer component comprises:

(A) 40-60 wt % of tetrahydrofurfuryl (meth)acrylate monomers;

(B) 40-60 wt % of alkyl (meth)acrylate ester monomers; and

(C) 0-10 wt % of cationically reactive functional monomers;

wherein the sum of (A), (B), and (C) is 100 wt % of the THFA copolymer.

Embodiment 17 provides the bonded abrasive article precursor of any one of Embodiments 14-16, wherein the curable composition comprises: i) from about 15 to about 50 parts by weight of the THF (meth)acrylate copolymer component; ii) from about 25 to about 50 parts by weight of the one or more epoxy resins; iii) from about 5 to about 15 parts by weight of the one or more hydroxy-functional polyethers; iv) from about 10 to about 25 parts by weight of one or more hydroxyl-containing film-forming polymers; where the sum of i) to iv) is 100 parts by weight; and v) from about 0.1 to about 5 parts by weight of a photoinitiator, relative to the 100 parts of i) to iv).

Embodiment 18 provides the bonded abrasive article precursor of any one of Embodiments 14-17, wherein the one or more hydroxy-functional polyethers is a liquid.

Embodiment 19 provides the bonded abrasive article precursor of any one of Embodiments 12 or 18, wherein the polyester polyol comprises polyglycolic acid, polybutylene succinate, poly(3-hydroxybutyrate-co-3-hydroxyvalerate), polyethylene terephthalate, polybutylene terephthalate, polytrimethylene terephthalate, polyethylene naphthalate, poly(1,4-butylene adipate), poly(1,6-hexamethylene adipate), poly(ethylene-adipate), mixtures thereof, or copolymers thereof.

Embodiment 20 provides the bonded abrasive article precursor of any one of Embodiments 12-19, wherein the curable composition is an epoxy composition that comprises one or more epoxy resins.

Embodiment 21 provides the bonded abrasive article precursor of any one of Embodiments 12-20, wherein the curable composition is a polyurethane composition.

Embodiment 22 provides the bonded abrasive article precursor of any one of Embodiments 1-21, wherein the plurality of abrasive particles are in a range of from about 5 wt % to about 80 wt % of the curable composition.

Embodiment 23 provides the bonded abrasive article precursor of any one of Embodiments 1-22, wherein the plurality of abrasive particles are in a range of from about 50 wt % to about 80 wt % of the curable composition.

Embodiment 24 provides the bonded abrasive article precursor of any one of Embodiments 1-23, at least one of the shaped abrasive particles of the plurality of abrasive particles comprises shaped abrasive particles that are tetrahedral and comprise four faces joined by six edges terminating at four tips, each one of the four faces contacting three of the four faces.

Embodiment 25 provides the bonded abrasive article precursor of Embodiment 24, wherein at least one of the four faces is substantially planar.

Embodiment 26 provides the bonded abrasive article precursor of Embodiments 24 or 25, wherein at least one of the four faces is concave.

Embodiment 27 provides the bonded abrasive article precursor of Embodiment 24, wherein all of the four faces are concave.

Embodiment 28 provides the bonded abrasive article precursor of any one of Embodiments 24 or 26, wherein at least one of the four faces is convex.

Embodiment 29 provides the bonded abrasive article precursor of Embodiment 24, wherein all of the four faces are convex.

Embodiment 30 provides the bonded abrasive article precursor of any one of Embodiments 24-29, wherein at least one of the tetrahedral abrasive particles has equally-sized edges.

Embodiment 31 provides the bonded abrasive article precursor of any one of Embodiments 24-30, wherein at least one of the tetrahedral abrasive particles has different-sized edges.

Embodiment 32 provides the bonded abrasive article precursor of any one of Embodiments 1-31, wherein at least one of the abrasive particles of the plurality of abrasive particles are a shaped abrasive particle having a first side and a second side separated by a thickness t, the first side comprises a first face having a triangular perimeter and the second side comprises a second face having a triangular perimeter, wherein the thickness t is equal to or smaller than the length of the shortest side-related dimension of the particle.

Embodiment 33 provides the bonded abrasive article precursor of Embodiment 32, wherein the shaped abrasive particle further comprises at least one sidewall connecting the first side and the second side.

Embodiment 34 provides the bonded abrasive article precursor of Embodiment 33, wherein the at least one sidewall of the shaped abrasive particle is a sloping sidewall.

Embodiment 35 provides the bonded abrasive article precursor of any one of Embodiments 33 or 34, wherein a draft angle α of the sloping sidewall of the shaped abrasive particle is in a range of from about 95 degrees and about 130 degrees.

Embodiment 36 provides the bonded abrasive article precursor of any one of Embodiments 32-35, wherein the first face and the second face of the shaped abrasive particle are substantially parallel to each other.

Embodiment 37 provides the bonded abrasive article precursor of any one of Embodiments 32-36, wherein the first face and the second face of the shaped abrasive particle are substantially non-parallel to each other.

Embodiment 38 provides the bonded abrasive article precursor of any one of Embodiments 32-37, wherein at least one of the first and the second face of the shaped abrasive particle are substantially planar.

Embodiment 39 provides the bonded abrasive article precursor of any one of Embodiments 32-38, wherein at least one of the first and the second face of the shaped abrasive particle is a non-planar face.

Embodiment 40 provides the bonded abrasive article precursor of any one of Embodiments 1-39, wherein one or more of the abrasive particles are a shaped abrasive particle comprising a cylindrical body extending between circular first and second ends.

Embodiment 41 provides the bonded abrasive article precursor of any one of Embodiments 1-39, wherein at least one of the abrasive particles comprises an opening, a concave surface, a convex surface, a groove, a ridge, a fractured surface, a low roundness factor, a perimeter comprising one or more corner points having a sharp tip, or a combination thereof.

Embodiment 42 provides the bonded abrasive article precursor of any one of Embodiments 1-41, wherein at least some of the plurality of abrasive particles comprise a ceramic material.

Embodiment 43 provides the bonded abrasive article precursor of any one of Embodiments 1-42, wherein at least some of the plurality of abrasive particles comprise alpha alumina, sol-gel derived alpha alumina, powder derived alumina, or a mixture thereof.

Embodiment 44 provides the bonded abrasive article precursor of any one of Embodiments 1-43, wherein at least some of the plurality of abrasive particles comprise an aluminosilicate, an alumina, a silica, a silicon nitride, a carbon, a glass, a metal, an alumina-phosphorous pentoxide, an alumina-boria-silica, a zirconia, a zirconia-alumina, a zirconia-silica, a fused aluminum oxide, a heat-treated aluminum oxide, a ceramic aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.

Embodiment 45 provides the bonded abrasive article precursor of any one of Embodiments 1-44, wherein one or more of the plurality of abrasive particles comprises a reaction product of a polymerizable mixture including one or more polymerizable resins.

Embodiment 46 provides the bonded abrasive article precursor of Embodiment 45, wherein the one or more polymerizable resins are chosen from a phenolic resin, a urea formaldehyde resin, a urethane resin, a melamine resin, an epoxy resin, a bismaleimide resin, a vinyl ether resin, an aminoplast resin, an acrylate resin, an acrylated isocyanurate resin, an isocyanurate resin, an acrylated urethane resin, an acrylated epoxy resin, an alkyd resin, and mixtures thereof.

Embodiment 47 provides the bonded abrasive article precursor of any one of Embodiments 45 or 46, wherein the polymerizable mixture further comprise at least one of a plasticizer, a catalyst, a cross-linker, a surfactant, a mild abrasive, a pigment, and an antibacterial agent.

Embodiment 48 provides the bonded abrasive article precursor of Embodiment 47, wherein the polymerizable resin is in a range of from about 35 wt % to about 100 wt % of the polymerizable mixture.

Embodiment 49 provides the bonded abrasive article precursor of any one of Embodiments 47 or 48, wherein the polymerizable resin is in a range of from about 40 wt % to about 95 wt % of the polymerizable mixture.

Embodiment 50 provides the bonded abrasive article precursor of any one of Embodiments 45-49, wherein the cross-linker is in a range of from about 2 wt % to about 15 wt % of the polymerizable mixture.

Embodiment 51 provides the bonded abrasive article precursor of any one of Embodiments 45-50, wherein the cross-linker is in a range of from about 5 wt % to about 10 wt % of the polymerizable mixture.

Embodiment 52 provides the bonded abrasive article precursor of any one of Embodiments 45-51, wherein the mild abrasive is in a range of from 5 wt % to about 65 wt % of the polymerizable mixture.

Embodiment 53 provides the bonded abrasive article precursor of any one of Embodiments 45-52, wherein the mild abrasive is in a range of from 10 wt % to about 20 wt % of the polymerizable mixture.

Embodiment 54 provides the bonded abrasive article precursor of any one of Embodiments 45-53, wherein the plasticizer is in a range of from 5 wt % to about 40 wt % of the polymerizable mixture.

Embodiment 55 provides the bonded abrasive article precursor of any one of Embodiments 45-54, wherein the plasticizer is in a range of from 10 wt % to about 15 wt % of the polymerizable mixture.

Embodiment 56 provides the bonded abrasive article precursor of any one of Embodiments 45-55, wherein the catalyst is in a range of from 1 wt % to about 20 wt % of the polymerizable mixture.

Embodiment 57 provides the bonded abrasive article precursor of any one of Embodiments 45-56, wherein the catalyst is in a range of from 5 wt % to about 10 wt % of the polymerizable mixture.

Embodiment 58 provides the bonded abrasive article precursor of any one of Embodiments 45-57, wherein the surfactant is in a range of from 1 wt % to about 15 wt % of the polymerizable mixture.

Embodiment 59 provides the bonded abrasive article precursor of any one of Embodiments 45-58, wherein the surfactant is in a range of from 5 wt % to about 10 wt % of the polymerizable mixture.

Embodiment 60 provides the bonded abrasive article precursor of any one of Embodiments 45-59, wherein the antimicrobial agent is in a range of from 5 wt % to about 20 wt % of the polymerizable mixture.

Embodiment 61 provides the bonded abrasive article precursor of any one of Embodiments 45-60, wherein the antimicrobial agent is in a range of from 10 wt % to about 15 wt % of the polymerizable mixture.

Embodiment 62 provides the bonded abrasive article precursor of any one of Embodiments 45-61, wherein the pigment is in a range of from 1 wt % to about 10 wt % of the polymerizable mixture.

Embodiment 63 provides the bonded abrasive article precursor of any one of Embodiments 45-62, wherein the pigment is in a range of from 3 wt % to about 5 wt % of the polymerizable mixture.

Embodiment 64 provides the bonded abrasive article precursor of any one of claims 1-63, further comprising crushed abrasive particles.

Embodiment 65 provides the bonded abrasive article precursor of Embodiment 64, wherein the crushed abrasive particles are in a range of from about 5 wt % to about 80 wt % of the curable composition.

Embodiment 66 provides the bonded abrasive article precursor of any one of Embodiments 64 or 65, wherein the crushed abrasive particles are in a range of from about 20 wt % to about 50 wt % of the curable composition.

Embodiment 67 provides the bonded abrasive article precursor of any one of Embodiments 1-66, wherein one or more of the plurality of abrasive particles are arranged in the curable composition in a predetermined pattern.

Embodiment 68 provides the bonded abrasive article precursor of Embodiment 67, wherein the predetermined pattern comprises a plurality of circles.

Embodiment 69 provides the bonded abrasive article precursor of any one of Embodiments 67 or 68, wherein the predetermined pattern comprises a plurality of substantially parallel lines.

Embodiment 70 provides the bonded abrasive article precursor of any one of Embodiments 1-69, wherein a z-direction rotational angle of individual abrasive particles of the plurality of abrasive particles is substantially the same.

Embodiment 71 provides the bonded abrasive article precursor of any one of Embodiments 1-70, further comprising a pigment component.

Embodiment 72 provides a bonded abrasive article, comprising a cured product of the curable composition of any one of Embodiments 1-71.

Embodiment 73 provides the bonded abrasive article of Embodiment 72, wherein the cured product comprises a cured epoxy network.

Embodiment 74 provides the bonded abrasive article of Embodiment 72, wherein the cured product comprises a polyurethane network and acrylate network, or a combination thereof.

Embodiment 75 provides the bonded abrasive article of any one of Embodiments 72-74, wherein the cured product has a first major surface and an opposed second major surface each contacting a peripheral side surface and a central axis extends through the first and second major surfaces.

Embodiment 76 provides the bonded abrasive article of Embodiment 75, wherein the first major surface and the second major surface are different sizes.

Embodiment 77 provides the bonded abrasive article of any one of Embodiments 72-76, wherein the plurality of abrasive particles are arranged as one or more layers of abrasive particles.

Embodiment 78 provides the bonded abrasive article of any one of Embodiments 72-77, wherein the first major surface and the second major surface have a substantially circular profile.

Embodiment 79 provides the bonded abrasive article of any one of Embodiments 72-78, further comprising a central aperture extending at least partially between the first and second major surfaces.

Embodiment 80 provides the bonded abrasive article of Embodiment 79, wherein the central axis extends through the central aperture.

Embodiment 81 provides the bonded abrasive article of any one of Embodiments 72-80, wherein the article comprises a reinforcing layer.

Embodiment 82 provides the bonded abrasive article of Embodiment 81, wherein the reinforcing layer comprises a polymeric film, a metal foil, a woven fabric, a knitted fabric, paper, vulcanized fiber, a staple fiber, a continuous fiber, a nonwoven, a foam, a screen, a laminate, and combinations thereof.

Embodiment 83 provides the bonded abrasive article of any one of Embodiments 72-82, wherein the abrasive article is at least one of a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, and a double disk grinding wheel.

Embodiment 84 provides the bonded abrasive article of any one of Embodiments 72-83, wherein a diameter of the bonded abrasive article is in a range of from about 2 mm to about 2000 mm.

Embodiment 85 provides the bonded abrasive article of any one of Embodiments 72-84, wherein a diameter of the bonded abrasive article is in a range of from about 100 mm to about 1000 mm.

Embodiment 86 provides the bonded abrasive article of any one of Embodiments 72-85, wherein water comprises less than about 2 wt % of the bonded abrasive article.

Embodiment 87 provides the bonded abrasive article of any one of Embodiments 72-86, wherein a about 80% to about 100% of the reactants are polymerized.

Embodiment 88 provides a method of making the bonded abrasive article of any one of Embodiments 72-87, the method comprising curing the curable composition of any one of Embodiments 1-71.

Embodiment 89 provides the method of Embodiment 88, wherein the curable composition is cured at a temperature in a range of from about 25° C. to about 160° C.

Embodiment 90 provides the method of any one of Embodiments 88 or 89, wherein the curable composition is cured at a temperature in a range of from about 100° C. to about 150° C.

Embodiment 91 provides the method of any one of Embodiments 88-90, wherein the curable composition is cured at a temperature of about 160° C. or less.

Embodiment 92 provides the method of any one of Embodiments 88-91, wherein the curable composition is cured for an amount of time in a range of from about 0.5 minutes to about 45 minutes.

Embodiment 93 provides the method of any one of Embodiments 88-92, wherein the curable composition is cured for an amount of time in a range of from about 1 minute to about 10 minutes.

Embodiment 94 provides the method of any one of Embodiments 88-93, wherein the curable composition is disposed in a mold and cured therein.

Embodiment 95 provides the method of Embodiment 94, wherein the plurality of abrasive particles are disposed in an apparatus and released into the curable composition disposed in the mold.

Embodiment 96 provides the method of Embodiment 95, wherein the apparatus comprises:

a housing comprising a first apparatus major surface, an opposed second apparatus major surface, and a peripheral surface connecting the first apparatus major surface and the second apparatus major surface;

wherein the first apparatus major surface comprises a plurality of holes each adapted to receive an abrasive particle.

Embodiment 97 provides the method of any one of Embodiments 95 or 96, wherein the first apparatus major surface has a substantially planar profile.

Embodiment 98 provides the method of any one of Embodiments 95-97, wherein the housing comprises an inlet adapted to connect to a vacuum generator.

Embodiment 99 provides the method of any one of Embodiments 95-98, further comprising a magnet aligned with at least one of the holes of the first surface.

Embodiment 100 provides the method of Embodiment 99, wherein the magnet is located within the housing.

Embodiment 101 provides the method of any one of Embodiments 95-100, wherein a majority of the holes are substantially the same size.

Embodiment 102 provides the method of any one of Embodiments 95-101, wherein the plurality of holes comprise a first hole and a second hole, wherein a size of at least the first hole and the second hole are different.

Embodiment 103 provides the method of any one of Embodiments 95-102, wherein at least one of the holes has a polygonal shape.

Embodiment 104 provides the method of any one of Embodiments 88-103, further comprising:

contacting the cured composition with a phenolic resin, a vitrified binder, a metallic binder, or a mixture thereof; and

curing the phenolic resin material, the vitrified binder material, the metallic binder material, or a mixture thereof.

Embodiment 105 provides the method of any one of Embodiments 88-104, further comprising exposing the abrasive particles to a magnetic field.

Embodiment 106 provides the method of Embodiment 105, further comprising rotating the abrasive particles with the magnetic field.

Embodiment 107 provides a method of using the abrasive article of any one of Embodiments 72-106, comprising:

moving the abrasive article with respect to a surface contacted therewith, to abrade the surface.

1. A bonded abrasive article precursor comprising
a curable composition comprising:
a curative component; and
one or more resins, wherein the curable composition is curable in an amount of time in a range of from about 0.1 minutes to about 20 minutes at a temperature of about 25° C. to about 160° C.; and
a plurality of abrasive particles dispersed in the curable composition.

2. The bonded abrasive article precursor of claim 1, wherein the curative component is in a range of from about 0.1 wt % to about 40 wt % of the curable composition.

3. The bonded abrasive article of claim 1, wherein the curative component comprises an acid catalyst, a base catalyst, an amphoteric catalyst, an aliphatic polyamine, an aromatic polyamine, an aromatic polyamide, an alicyclic polyamine, a polyamine, a polyamide, an amino resin, a 9,9-bis(aminophenyl)fluorene, a polyisocyanate, a polyol chain extender, imidazole, a dicyandiamide, or a mixture thereof.

4. The bonded abrasive article precursor of claim 1, wherein the one or more resins are in a range of from about 20 wt % to about 99.9 wt % of the curable composition.

5. The bonded abrasive article precursor of claim 1, wherein the one or more resins comprise an epoxy resin, an acrylated epoxy resin, a polyester polyol, a polyisocyante, a polyol, or a mixture thereof.

6. The bonded abrasive article precursor of claim 5, wherein the curable composition is an epoxy composition that comprises one or more epoxy resins.

7. The bonded abrasive article precursor of claim 6, wherein the epoxy resin is chosen from a diglycidyl ether of bisphenol F, a low epoxy equivalent weight diglycidyl ether of bisphenol A, a liquid epoxy novolac, a liquid aliphatic epoxy, a liquid cycloaliphatic epoxy, a 1,4-cyclohexandimethanoldiglycidylether, 3,4-epoxycyclohexylmethyl-3,4-epoxycyclohexane carboxylate, tetraglycidylmethylenedianiline, N,N,N′,N′-tetraglycidyl-4,4′-methylenebisbenzenamine, a triglycidyl of para-aminophenol, N,N,N′,N′-tetraglycidyl-m-xylenediamine, and a mixture thereof.

8. The bonded abrasive article precursor of claim 1, wherein the curable composition is a polyurethane composition.

9. The bonded abrasive article precursor of claim 1, wherein the plurality of abrasive particles are shaped abrasive particles.

10. A bonded abrasive article, comprising a cured product of the curable composition of claim 1.

11. The bonded abrasive article of claim 10, wherein the cured product comprises a plurality of layers, wherein a composition of at least two of the layers are different.

12. The bonded abrasive article of claim 11, wherein the abrasive article is at least one of a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, abrasive segments and a double disk grinding wheel.

13. A method of making the bonded abrasive article of claim 10.

14. The method of claim 13, wherein the curable composition is disposed in a mold and cured therein.

15. A method of using the abrasive article of claim 14, comprising:
moving the abrasive article with respect to a surface contacted therewith, to abrade the surface.
